(19) United States
(12) Patent Application Publication
(10) Pub. No.: US 2026/0289146 A1
(43) Pub. Date: Sep. 24, 2026

(54) SYSTEM

(71) Applicant: SoftBank Group Corp., Tokyo (JP)

(72) Inventor: Natsuki KODA, Tokyo (JP)

(73) Assignee: SoftBank Group Corp., Tokyo (JP)

(21) Appl. No.: 19/567,296

(22) Filed: Mar. 16, 2026

(30) Foreign Application Priority Data
Mar. 19, 2025 (JP) 2025-045044

(51) Int. Cl. G06F 40/35; G06N 3/0464; G06N 3/0475

(52) U.S. Cl. CPC G06F 40/35; G06N 3/0464; G06N 3/0475

(57) ABSTRACT

A system includes a processor that is configured to analyze content of digital content to be posted, generate a prompt to instruct a generative artificial intelligence model to identify inappropriate elements in the digital content, explain reasons for the identified elements to a user in natural language, and recognize an emotion of the user and adjust candidates of edited digital content based on the recognized emotion.

### CROSS-REFERENCE TO RELATED APPLICATION

This application is based on and claims priority under 35 USC 119 from Japanese Patent Application No. 2025-045044 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional content moderation workflows for user-generated digital content, such as short videos, images, and audio clips, typically rely on either manual review or automated rule-based filters and machine learning classifiers. These approaches suffer from several problems. First, conventional systems often cannot provide users with transparent, natural-language explanations as to why specific portions of their content are considered inappropriate, which leads to user dissatisfaction and difficulty in voluntarily correcting the content. Second, conventional systems generally do not generate or utilize prompts tailored to generative artificial intelligence models for identifying inappropriate elements in a flexible and context-aware manner, thereby limiting detection accuracy and adaptability to new or nuanced types of harmful content. Third, existing systems rarely take into account the emotional state of the user during the moderation and editing process; as a result, proposed edits or recommendations may be perceived as insensitive, overly strict, or not aligned with the user's expectations, which can further reduce user engagement and acceptance of automated moderation. Fourth, existing systems typically do not provide interactive, real-time candidate editing flows that allow the user to quickly review, compare, and select edited content versions in response to moderation outcomes. Accordingly, there is a need for a system that analyzes digital content to be posted, cooperates effectively with a generative artificial intelligence model via appropriate prompts to identify inappropriate elements, explains the reasons for such identifications to the user in natural language, recognizes the user's emotion, and adjusts candidates of edited digital content based on the recognized emotion, while supporting interactive presentation and real-time user selection of edited content candidates.

### SUMMARY

In order to solve the above-described problems, according to one aspect of the invention, there is provided a system comprising a processor, wherein the processor is configured to analyze content of digital content to be posted, generate a prompt to instruct a generative artificial intelligence model to identify inappropriate elements in the digital content, explain reasons for the identified elements to a user in natural language, and recognize an emotion of the user and adjust candidates of edited digital content based on the recognized emotion. The processor may analyze visual information and audio information of the digital content on a frame-by-frame basis, and input the analyzed visual information and audio information as the prompt to instruct the generative artificial intelligence model to identify the inappropriate elements. By generating and supplying such prompts, the system leverages the generative artificial intelligence model to flexibly and accurately identify inappropriate elements, including context-dependent or newly emerging types of problematic content. Further, the processor may present the candidates of the edited digital content to the user through an interactive interface, and receive a selection from the user in real time.

Through this interactive interface, the system can display multiple alternative edited versions of the digital content, each reflecting different ways of removing, masking, or modifying the identified inappropriate elements, and can dynamically adapt those candidates in accordance with the recognized user emotion so that the user is more likely to accept and utilize the proposed edits.

The term “system” refers to a combination of one or more hardware components and software components that cooperate to perform the processing steps described in the claims, including analysis of digital content, interaction with a generative artificial intelligence model, user interaction, and content editing.

The term “processor” refers to one or more processing units, such as a central processing unit (CPU), graphics processing unit (GPU), digital signal processor (DSP), or other programmable logic or execution hardware, configured by software or firmware to execute instructions and perform the functions recited in the claims.

The term “digital content” refers to electronically stored or transmitted media data, including but not limited to video, audio, images, text, or combinations thereof, that is intended to be posted or shared on an online platform or service.

The term “content of digital content to be posted” refers to the substantive media information contained in the digital content, including visual, audio, and textual information, before the digital content is published or made accessible to other users on an online platform.

The term “analyze” refers to processing, inspecting, or evaluating data, such as visual or audio information, using algorithms, models, or rules in order to extract features, detect patterns, or derive information relevant to identifying inappropriate elements.

The term “visual information” refers to information derived from image or video data, including pixel values, frames, motion vectors, detected objects, scenes, or other visual features that can be extracted from digital images or video content.

The term “audio information” refers to information derived from sound signals, including raw audio waveforms, frequency components, speech content, background sounds, music, or other acoustic features that can be extracted from digital audio or video content.

The term “frame-by-frame basis” refers to processing that is performed for individual frames or for discrete time units of the digital content, such that visual information and audio information are analyzed with temporal resolution sufficient to identify the start and end times of specific elements within the content.

The term “prompt” refers to a data structure or input instruction set, including text, structured parameters, or other representations, that is provided to a generative artificial intelligence model to specify a task, such as identifying inappropriate elements in digital content.

The term “generative artificial intelligence model” refers to a machine learning model, such as a generative neural network, transformer model, or other generative model, that can produce or transform data, including generating explanations, classifications, or edited content based on input prompts and training data.

The term “inappropriate elements” refers to parts, segments, or characteristics of the digital content that may violate predetermined policies, guidelines, or legal requirements, including but not limited to violence, hate speech, abusive language, sexual content, or other harmful or undesirable material.

The term “identify inappropriate elements” refers to determining the presence, type, and location or time range of inappropriate elements within the digital content, based on analysis and model outputs.

The term “explain reasons” refers to providing to the user a description of why certain elements in the digital content have been identified as inappropriate, including indicating relevant policies, categories, or characteristics that triggered the identification.

The term “natural language” refers to a human language, such as English or Japanese, expressed in words and phrases understandable to a typical user, as opposed to machine code, mathematical notation, or low-level symbolic representations.

The term “user” refers to a human operator who creates, uploads, edits, or manages digital content using the system and who receives explanations and edit proposals from the system. The term “recognize an emotion of the user” refers to determining or estimating an emotional state of the user, such as satisfaction, frustration, confusion, acceptance, or rejection, based on input signals including but not limited to user interactions, textual input, voice input, facial expressions, or other behavioral data.

The term “candidates of edited digital content” refers to two or more alternative versions of the original digital content in which one or more inappropriate elements have been removed, masked, altered, or otherwise modified by the system according to different editing strategies. The term “adjust candidates of edited digital content based on the recognized emotion” refers to modifying, reordering, filtering, or generating the candidates of edited digital content in a manner that takes into account the recognized emotional state of the user, such that the presentation and content of the candidates are better aligned with the user's preferences or sensitivities.

The term “interactive interface” refers to a graphical user interface, web interface, application screen, or similar user interface that allows the user to receive information from the system and to provide input to the system through operations such as clicking, tapping, dragging, selecting, or entering text, in a responsive and dynamic manner.

The term “present the candidates of the edited digital content” refers to displaying or otherwise outputting representations of the candidates, such as thumbnails, preview videos, descriptions, or timelines, in a way that allows the user to understand and compare the proposed edited versions.

The term “receive a selection from the user in real time” refers to detecting and processing a user's choice of one of the candidates of the edited digital content promptly after the user performs an input action, without substantial delay, so that the system can immediately proceed with further processing based on the selected candidate.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

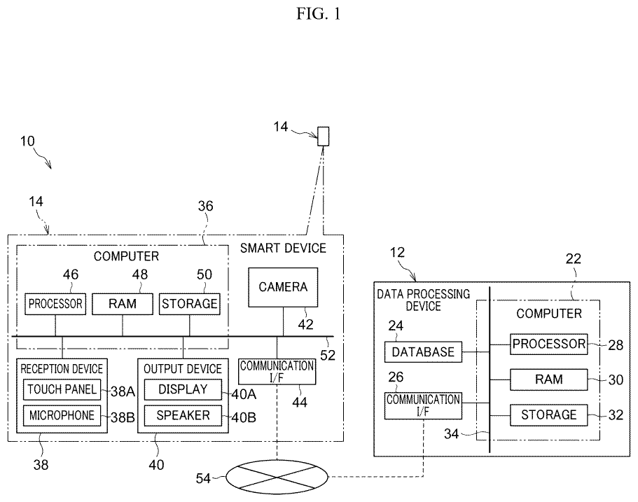

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

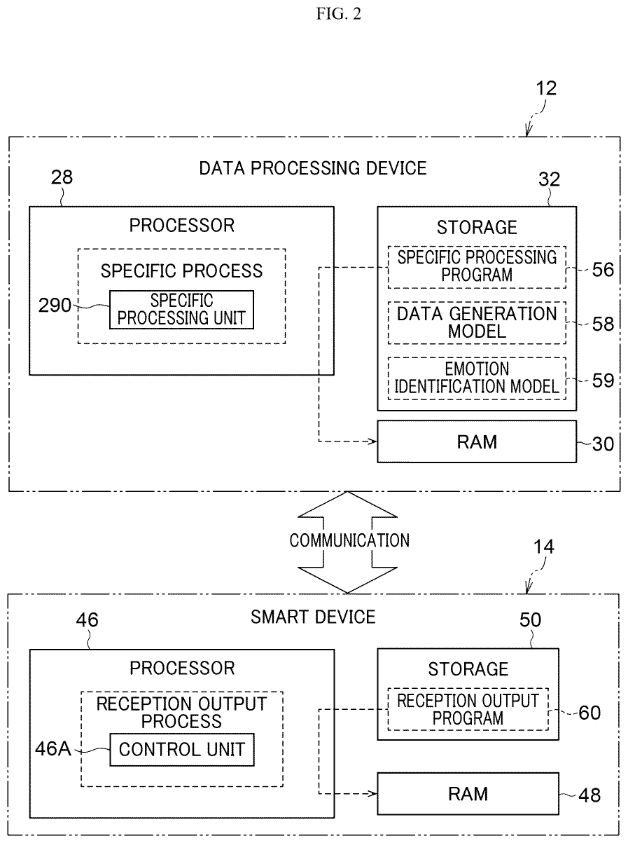

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In online distribution environments, authors increasingly create and upload time-series media information such as video and audio content to various platforms. Conventional content moderation workflows rely on manual review or simple rule-based filters that operate on either visual information or audio information in isolation. As a result, it is difficult to accurately and consistently detect potentially inappropriate elements, such as violent scenes or excessive profanity, that arise from a combination of visual context and spoken language over time.

Furthermore, conventional tools that merely flag questionable segments do not provide detailed, user-understandable reasons for why certain portions of the content are considered potentially inappropriate. This lack of transparency hinders user trust and makes it difficult for content creators to understand platform policies or improve their content creation practices.

In addition, even when problematic segments are identified, existing systems generally provide only rudimentary editing functions, such as simple cutting of entire scenes. Such functions are not well integrated with automated detection results, and they do not leverage generative information processing models to generate nuanced, context-sensitive editing proposals. As a consequence, users must manually experiment with editing operations, which increases processing time and computational resource usage and often leads to suboptimal or inconsistent outcomes.

From a computer technology standpoint, there is a need for a technical mechanism that (i) automatically integrates heterogeneous analysis results obtained from visual and audio analysis components into a unified time-series representation, (ii) programmatically generates structured prompt sentences for generative information processing models based on that representation, and (iii) automatically converts model outputs into concrete media editing operation sequences. Existing systems typically treat these stages as disjoint manual steps, causing repeated data transformation, inefficient use of external analysis functions and generative models, and error-prone human intervention.

Therefore, a technical problem exists in providing a computer-implemented system and server-side processing that improve the efficiency, accuracy, and explainability of detecting potentially inappropriate elements in time-series media information, and that reliably translate such detections into concrete editing operations. Another technical problem lies in enabling scalable and reproducible generation of multiple edited media candidates and interaction with user terminals, while maintaining machine-optimized internal representations and minimizing redundant processing loads on computing resources.

The specific processing by the specific processing unit 290 of the data processing device 12 in Example 1 is realized by the following means.

The present invention provides a server comprising a processor configured to analyze content of information including time-series media information scheduled to be posted, and to generate integrated time-series information by integrating visual information and audio information obtained from the time-series media information on the basis of time information, to extract, on the basis of the integrated time-series information, time intervals including elements that are potentially inappropriate and to generate element information including, for each time interval, a type of the potentially inappropriate element and evidence information related to the element, to generate a prompt sentence, on the basis of the element information and the integrated time-series information, for instructing a generative information processing model to identify the potentially inappropriate elements and to generate editing proposals, and to input the prompt sentence into the generative information processing model to obtain response information including editing proposals for each time interval, to generate, on the basis of the element information and the response information, explanation information that explains, in natural language, reasons why the potentially inappropriate elements are determined to be inappropriate, and to cause a user terminal to present the explanation information, and to determine an editing operation sequence, on the basis of the response information and editing operation information received from a user, the editing operation sequence applying, to the time-series media information for each time interval, at least one editing process selected from a deletion process, a masking process, an audio disabling process, and another editing process, and to generate a plurality of edited time-series media information candidates in accordance with the editing operation sequence, and to cause the user terminal to present the edited time-series media information candidates and to determine final edited time-series media information on the basis of selection information received from the user. This enables the server to implement an integrated technical pipeline in which heterogeneous analysis results are normalized into a unified time-aligned representation, prompt sentences for a generative information processing model are automatically constructed from structured internal data, model outputs are programmatically converted into concrete media editing operations, and multiple edited media candidates with associated natural-language explanations are efficiently generated and managed, thereby improving the performance, scalability, and reliability of computer-based moderation and editing of time-series media information.

The term “time-series media information” refers to information that changes as a function of time and includes at least one of moving image data and audio data, such as video content, audio content, or combined audiovisual content that can be segmented into time intervals.

The term “visual information” refers to information obtained from image data included in time-series media information, including but not limited to frame images, detected objects, labels, scenes, or other visual features associated with time positions.

The term “audio information” refers to information obtained from audio data included in time-series media information, including but not limited to sound signals, spoken words, music, sound effects, and other acoustic features associated with time positions. The term “integrated time-series information” refers to data in which visual information and audio information derived from time-series media information are associated with a common time reference and are stored or managed in a unified time-aligned structure.

The term “time interval” refers to a section of the time axis of the time-series media information, specified by a start time and an end time, and used as a unit for analysis, detection, and editing.

The term “potentially inappropriate element” refers to an element included in the time-series media information that may be considered unsuitable for a target audience or usage context, including but not limited to violence, explicit content, hate speech, or excessive profanity. The term “element information” refers to structured information associated with a time interval and describing at least a type of a potentially inappropriate element and evidence information indicating a basis for determining the element.

The term “evidence information” refers to information that supports a determination that a potentially inappropriate element is present, including but not limited to visual annotations, recognized words or phrases in a transcript, confidence scores, and classification results produced by analysis functions.

The term “generative information processing model” refers to a computational model configured to generate output information such as text or structured data in response to input information, including but not limited to a generative artificial intelligence model that processes prompt sentences and produces explanations or editing proposals.

The term “prompt sentence” refers to information, including natural-language text and optionally structured data, that is input to a generative information processing model to specify a task, provide context, and request generation of particular output such as identification of potentially inappropriate elements and editing proposals.

The term “response information” refers to information output by the generative information processing model in response to a prompt sentence, and includes at least editing proposals and optionally explanations, classifications, and other auxiliary data.

The term “explanation information” refers to natural-language information that explains reasons why a time interval is determined to include a potentially inappropriate element, and that is presented to a user to improve understanding of the determination.

The term “editing operation sequence” refers to an ordered set of editing operations to be applied to time-series media information, each editing operation being associated with at least one time interval and specifying a type of processing.

The term “deletion process” refers to an editing process in which time-series media information corresponding to a specified time interval is removed such that the corresponding segment is not included in an edited version.

The term “masking process” refers to an editing process in which at least part of visual information or audio information within a specified time interval is obscured, replaced, or otherwise made less perceivable, including processes such as blurring, pixelation, overlay, or content replacement.

The term “audio disabling process” refers to an editing process in which audio information within a specified time interval is reduced, muted, or replaced so that original sounds, including spoken words, are not audibly reproduced in the edited version.

The term “edited time-series media information candidate” refers to a version of time-series media information generated by applying an editing operation sequence, and managed as one candidate among multiple possible edited versions for user selection.

The term “final edited time-series media information” refers to an edited version of the time-series media information that has been selected by a user from among a plurality of edited time-series media information candidates and is treated as a completed output for distribution or posting.

The term “external information analysis function” refers to a processing function or service, implemented by hardware and/or software separate from the server's internal analysis logic, that analyzes visual information to generate annotation information such as labels, categories, or detection results.

The term “external audio analysis function” refers to a processing function or service, implemented by hardware and/or software separate from the server's internal analysis logic, that converts audio information into time-stamped character string information or other textual representations.

The term “annotation information” refers to metadata associated with the time-series media information, including but not limited to labels, categories, detection results, scores, and time positions produced by an analysis function.

The term “time-stamped character string information” refers to character string information, such as a transcript, in which words, phrases, or sentences are associated with time information indicating positions within the time-series media information.

The term “structured data” refers to data organized in a predetermined format such as key-value pairs, records, tables, or hierarchical objects, suitable for programmatic processing and embedding into a prompt sentence.

The term “user terminal” refers to an information processing apparatus operated by a user, such as a personal computer, smartphone, tablet, or other device that can communicate with the server, present information, and accept user input.

The term “editing operation information” refers to information indicating a user's selections or instructions regarding editing operations to be applied to time-series media information, including choices among deletion, masking, audio disabling, or other editing processes. The term “selection information” refers to information indicating a user's selection of one of a plurality of edited time-series media information candidates as a final edited version.

In one embodiment, a server executes a content moderation and editing system using one or more processors, system memory, nonvolatile storage, and a network interface. The server operates under control of an operating system such as a general-purpose server operating system. The server communicates with one or more terminals operated by users over a network using a communication protocol such as HTTPS. The terminal comprises a computing device such as a personal computer, a smartphone, or a tablet, and executes a browser application or a native application to present a graphical user interface and to transmit and receive data to and from the server.

The server stores program modules including a media ingestion module, an external analysis interface module, a time-series integration module, an inappropriate element detection module, a generative model interface module, an editing operation determination module, a media editing module, a data storage module, and a user interface communication module. The server stores data structures including raw media files, extracted audio files, visual annotation records, transcript records, unified timeline records, element information records, prompt sentence logs, response information records, editing operation sequences, and edited media candidates.

The server runs the media ingestion module to receive time-series media information from the terminal. The terminal reads a media file such as a video file with an audio track from local storage and transmits the file to the server via an upload interface. The server writes the received media data to nonvolatile storage, for example a disk array or a network storage device. The server records metadata such as file path, duration, resolution, and sampling rate in a database managed by a database management system.

The server uses the external analysis interface module to invoke external information analysis functions and external audio analysis functions. In one example, the server uses a video analysis service that accepts a video file or a reference thereto and returns annotation information including labels for scenes, objects, and explicit content, along with time offsets. The server sends a request containing a uniform resource identifier of the stored media file and specifies detection options such as label detection and explicit content detection. The server receives a structured response such as a JSON object and writes each annotation into a visual annotation table. Each record in the visual annotation table includes at least a content identifier, a label identifier, a confidence score, a start time, and an end time, where time is represented by a numeric value such as seconds from the beginning of the media.

The server uses the external audio analysis function to convert audio information into time-stamped character string information. The server executes a media processing software component such as FFmpeg to extract an audio-only file from the media file and stores the audio-only file. The server requests transcription of the audio file by an external transcription service, which returns a transcript including words or phrases, along with corresponding start and end times. The server stores each transcribed element as a record in a transcript table with fields such as content identifier, token string, token confidence score, token start time, and token end time.

The server executes the time-series integration module to generate integrated time-series information. The server defines a common time grid or uses the continuous time axis of the media as a reference. The server reads the visual annotation table and the transcript table and associates each annotation and each token with the common time reference. The server allocates a data structure, for example an array of segment objects, wherein each segment object contains a segment start time, a segment end time, one or more visual labels active in the interval, and all transcript tokens whose time span overlaps the interval. The server may select a segment duration such as 0.5 seconds, 1 second, or a variable length determined from shot changes or pauses in speech. The server stores the integrated time-series information as unified timeline records that link media identifier, segment identifier, time bounds, and attached visual and textual features.

The server runs the inappropriate element detection module to generate element information from the unified timeline. In one implementation, the server uses a combination of rule-based detection and a trained classifier. The server maintains a lexicon of tokens associated with profanity, hate speech, and other categories. The server scans transcript tokens in each segment and flags segments where one or more tokens appear in the lexicon above a threshold count or score. The server also evaluates visual labels, for example labels mapped to violence, weapons, nudity, or self-harm categories, and flags segments in which one or more such labels appear with confidence greater than a threshold. The server assigns preliminary issue types such as “violent visual,” “profane language,” or “explicit visual” to flagged segments.

The server, in addition, loads a neural network classifier from storage into memory. The classifier may have an architecture such as a multi-layer neural network that combines textual and visual features. In one embodiment, the server uses an input layer that receives a concatenated feature vector including word embedding features derived from transcript tokens in a segment and label embedding features derived from visual labels in the same segment. The server may generate word embeddings using a pre-trained embedding table, and generate label embeddings in a similar manner. The server uses subsequent layers such as one or more bidirectional recurrent layers, one or more fully connected layers, and an output layer producing probabilities for multiple inappropriate categories. The server normalizes probabilities using a softmax function or a sigmoid function depending on whether a multi-class or multi-label classification is implemented. The server, for each segment, computes a feature vector and passes the vector to the classifier to obtain category probabilities. The server flags a segment as including a potentially inappropriate element if a probability exceeds a threshold such as 0.5, or if a combination of probabilities satisfies a decision rule.

The server may have trained the classifier using supervised learning prior to deployment. The server uses a training dataset comprising many labeled segments with known inappropriate category labels. The server calculates a loss function such as cross-entropy loss between predicted probabilities and ground truth labels. The server updates model parameters using a gradient-based optimization algorithm such as stochastic gradient descent with momentum or an adaptive method. The server may apply regularization techniques such as dropout in intermediate layers and may augment the training data by shifting time windows, adding noise to audio, and applying simple geometric transformations to visual frames. By training the classifier on fused multimedia features, the server obtains a model that can detect cross-modal patterns that a human reviewer would find difficult to identify quickly and consistently.

The server stores, for each flagged segment, element information including at least a segment identifier, a time interval, a category label, and evidence information such as which transcript tokens and which visual labels triggered the decision and which classifier output probabilities exceeded thresholds. The server may record feature vectors or summary statistics to trace how the classifier reached a decision. This evidence information allows the server to generate detailed explanations and supports auditing.

The server executes the generative model interface module to construct and transmit prompt sentences to a generative AI model. The server selects element information and corresponding unified timeline records and serializes them into structured textual descriptions. For example, the server converts a flagged segment into a description such as “Segment from 00:01:23 to 00:01:29, visual labels: [‘fist’, ‘impact’, ‘person’], transcript: ‘I am going to hit you now!’, classifier category: ‘violent scene’ with probability 0.92.” The server then embeds this description into a prompt sentence in natural language.

In one example, the server constructs a prompt sentence as follows:
“Analyze the following video content metadata, transcript with timestamps, and visual labels. The content is intended for a general audience. 1) Identify all potentially inappropriate scenes, including violence, hate speech, explicit content, and excessive profanity. 2) For each identified scene, provide a brief explanation of why it is inappropriate, referencing specific words in the transcript or visual labels. 3) Propose at least two concrete editing options for each scene, such as cutting the time range, blurring the image, masking specific regions, or muting and replacing the audio. Return the result as concise, human-readable recommendations.”

The server may construct alternative prompt sentences tailored to specific audiences. In another example, the server constructs the following prompt sentence:
“You are assisting with safe editing of user-generated video content. The following video is intended for children under 12. Given the transcript with timestamps and the list of visual labels, identify all scenes that may be inappropriate for children, such as physical violence, scary imagery, or harsh language. For each problematic scene, explain why it is inappropriate and propose at least two concrete editing solutions (for example, cut the scene from 00:01:23 to 00:01:29, blur the screen while keeping audio, mute specific words). Use concise, user-friendly language suitable for a video creator interface.”

The server appends the segment descriptions and other structured data to the prompt sentence and transmits the prompt sentence to a generative AI model through a network API. The generative AI model may be a transformer-based language model trained on large text corpora and fine-tuned for instruction following. The server specifies generation parameters such as maximum output length, sampling strategy, and temperature to control output variability. The server receives response information including natural-language explanations and concrete suggested edits, for example statements such as “Cut the scene from 00:01:23 to 00:01:29 to remove the physical impact” and “Alternatively, blur the entire frame from 00:01:23 to 00:01:29 while keeping the audio.”

The server stores the response information in association with corresponding segments. The server uses the response information together with the evidence information to generate explanation information for presentation to the user. The user views explanations such as “This segment is considered violent because the system detected labels indicating impact between persons and the dialogue includes threats,” as well as editing options. Because the explanations reference specific tokens, labels, and classifier probabilities, the user can understand how the system arrived at a decision.

The server executes the editing operation determination module to transform editing proposals into an editing operation sequence that controls a media editing engine. The server maps each proposal into an operation type (such as delete, blur, mask region, mute, or replace audio) and associated parameters including time interval boundaries and regions of interest for video frames. The server then optimizes the operation sequence by merging adjacent or overlapping operations and by ordering operations to minimize repeated decoding and encoding of the media. For example, the server may perform a single decode pass and apply all video filters in a composite filter graph rather than decoding and encoding the media separately for each operation. This optimization reduces processing time and decreases the energy consumption of the server.

The server runs the media editing module using a media processing software component such as FFmpeg or GStreamer to apply the editing operation sequence. The server generates multiple edited time-series media information candidates according to different combinations of proposed edits. For instance, one candidate may remove a violent scene entirely, another may retain the scene but blur the region of impact, and another may mute the audio while retaining the video. The server stores each candidate as a separate media file and registers metadata such as applied operations, output duration, and file size.

The server transmits information about the edited candidates to the terminal. The terminal presents a graphical user interface showing thumbnail images or short preview clips of each candidate and lists the applied editing operations. The user uses the terminal to play the candidates, compare them, and select a preferred version. The terminal sends selection information to the server, and the server marks the selected candidate as final edited time-series media information. The server may standardize the encoding parameters of the final version to ensure compatibility with a distribution platform.

The server improves computer technology in several ways. First, the server reduces redundant data movement and duplicated computation by maintaining integrated time-series information that fuses visual and audio analysis results in a unified data structure. This enables the server to perform classification, prompt sentence generation, and editing planning without recomputing separate feature sets. Second, the server uses specialized neural network architectures that process fused multimodal features, which yields higher detection accuracy and fewer false positives compared to simple rule-based filters. Third, the server programmatically converts detection results into an optimized editing operation sequence, which minimizes decoding and encoding passes, thereby increasing throughput and reducing server load and network bandwidth usage when transmitting edited candidates.

The server also applies distinct rules and neural network-based decision criteria that are not mere automation of human judgment. The server uses specific lexical thresholds, label mappings, classifier probability thresholds, and conflict resolution rules to determine whether a segment is flagged. For example, the server may flag a scene as potentially inappropriate only if both visual evidence (such as a weapon label) and linguistic evidence (such as a threat phrase) co-occur, and the classifier probability surpasses a combined threshold. This type of multi-condition rule is systematically evaluated on high-dimensional feature vectors and time-aligned annotations, which would be impractical for a human reviewer to apply consistently at scale.

The server may also adapt or retrain the neural network classifier using logs collected during system operation. The server stores user feedback on false positives and false negatives and uses such feedback to update labels in the training dataset. The server then retrains the classifier by iterating over the updated dataset, computing gradients of the loss function with respect to network weights, and updating the weights. The server may adjust learning rate schedules and regularization parameters to balance convergence speed and generalization performance. By incorporating feedback loops, the server improves detection accuracy over time and thereby reduces redundant editing operations and unnecessary candidate generation. In another embodiment, the server deploys different network architectures, such as a convolutional neural network to process short visual clips combined with a recurrent network to process text tokens. The server may first extract low-level visual features using a convolutional encoder and aggregate them using temporal pooling operations to produce a segment-level vector. The server then concatenates this vector with a textual representation obtained from a recurrent or transformer-based encoder and passes the concatenated vector to a classifier head. This architecture can capture local motion patterns and contextual language simultaneously. Because the server executes these computations on specialized hardware such as graphical processing units or tensor processing units, the system achieves high throughput and can process many videos concurrently.

In a further embodiment, the server implements alternative generative models. For example, the server may use a smaller, domain-specific generative model deployed locally rather than a large external service. The server may tokenize the prompt sentence, embed tokens, and process them using a transformer network with self-attention layers to compute contextualized representations. The server decodes an output sequence that contains editing recommendations and explanations. The server may fine-tune this generative model using supervised learning on examples of human-generated editing recommendations to align its outputs with desired styles and policy constraints.

The terminal interacts with the server using an application layer protocol and displays the system outputs in a way that allows real-time interaction without requiring substantial local computation. The terminal sends only control messages and does not need to perform heavy media decoding or model inference, which reduces resource requirements on the terminal side. By centralizing heavy computation, the server can allocate resources dynamically and balance loads across multiple processors and accelerators.

In another variation, the server supports different categories of time-series media information, such as live recordings, screen capture videos, or multi-track audio. The server may adjust integration and detection logic according to the type of content. For example, for multi-track audio, the server processes each channel or track separately, identifies channel-specific inappropriate content, and then aggregates decisions across channels. For screen capture videos, the server may emphasize detection of textual overlay content using optical character recognition and incorporate recognized overlay text as additional features in the unified timeline.

Through these embodiments, the server provides a concrete technical solution that goes beyond abstract analysis or simple automation of human review. The server defines specific data structures for unified timelines, applies defined neural network architectures with associated training procedures, and generates and executes optimized editing operation sequences using media processing software. As a result, the system achieves improved detection accuracy, reduced processing time, and lower resource consumption compared to conventional systems, while enabling generation and management of multiple edited candidates with transparent explanations.

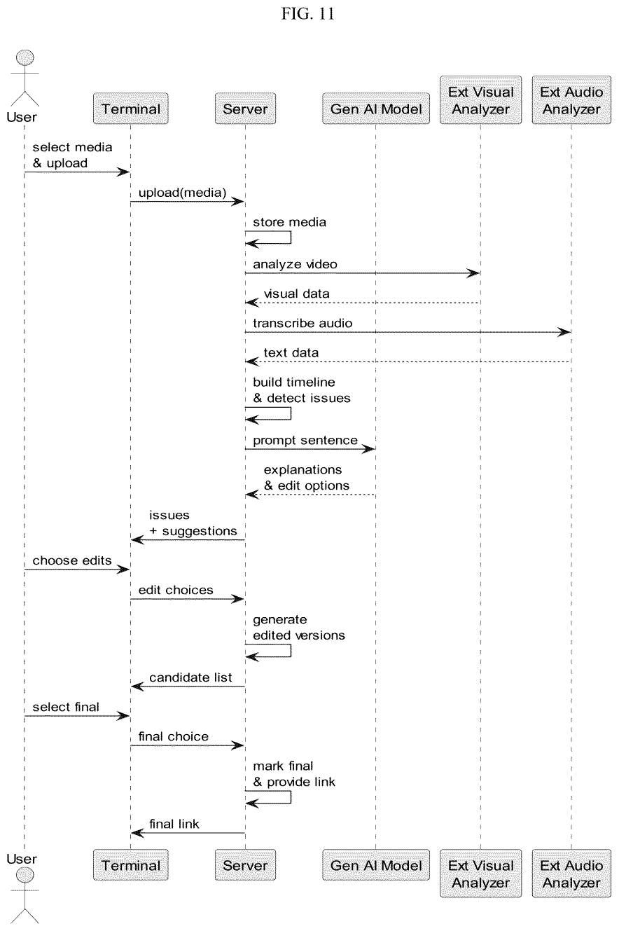

The following describes the processing flow using FIG. 11.

### Step 1

The user selects time-series media information on the terminal and initiates an upload operation.

The terminal takes as input a media file stored in local storage and user instructions such as a click on an “Upload” button, and outputs an HTTPS request that includes the media file data in a multipart/form-data body.

The terminal reads the selected file into memory, segments the file into packets, and transmits the packets over a network connection to the server.

### Step 2

The server receives the upload request and stores the time-series media information. The server takes as input the HTTP request containing the media file and outputs a stored media file and associated metadata records.

The server reads the binary media stream from the request body, writes the stream to nonvolatile storage as a media file, and generates metadata including a content identifier, file path, file size, and approximate duration, which the server stores in a database.

### Step 3

The server extracts audio information from the media file using a media processing component.

The server takes as input the stored media file and outputs an extracted audio file and audio metadata.

The server invokes a media processing tool, specifies the media file path and audio extraction parameters, decodes the original container, isolates the audio track, re-encodes or copies the audio into a separate file, and records the audio format, sampling rate, and duration in a database table.

### Step 4

The server invokes an external information analysis function to generate visual annotation information.

The server takes as input the media file location and analysis parameters, and outputs visual annotation records stored in a visual annotation table.

The server constructs a request containing a reference to the media file, sends the request to the external analysis service, receives structured annotation data including labels, scores, and time offsets, parses the data, and writes each annotation as a database record with content identifier, label identifier, confidence score, and time interval.

### Step 5

The server invokes an external audio analysis function to generate time-stamped character string information.

The server takes as input the extracted audio file and transcription parameters, and outputs transcript records stored in a transcript table.

The server sends a transcription request with audio file location and language information to the external service, periodically checks the job status, retrieves a transcript result when available, parses the transcript into tokens or phrases with start and end times, and stores each token with its confidence score in the database.

### Step 6

The server generates integrated time-series information by aligning visual and audio analysis results on a common time axis.

The server takes as input visual annotation records and transcript records and outputs unified timeline records.

The server defines segment boundaries along the media duration, retrieves all annotations and tokens, assigns each annotation or token to one or more segments based on overlapping time intervals, constructs data structures that aggregate labels and tokens per segment, and writes each segment with its start time, end time, visual label set, and token list into a unified timeline table.

### Step 7

The server executes rule-based detection to preliminarily identify potentially inappropriate segments.

The server takes as input unified timeline records and a rule set, and outputs flagged segment candidates with preliminary issue types.

The server reads each segment, checks token strings against a lexicon of sensitive terms, compares label identifiers against a mapping of sensitive categories, evaluates counts and scores against thresholds, and generates flagged candidate records including segment identifier, category type, and rule evidence when conditions are satisfied.

### Step 8

The server applies a trained neural network classifier to refine detection of potentially inappropriate elements.

The server takes as input unified timeline records and model parameters, and outputs classifier scores and refined flagged element records.

The server converts tokens in each segment into numeric embeddings, converts labels into numeric vectors, concatenates or otherwise combines these features into a feature vector, passes the vector through the neural network, computes output probabilities per category, compares the probabilities to predefined thresholds, and updates or creates element information records for segments with probabilities above thresholds.

### Step 9

The server generates element information including evidence information for each flagged segment.

The server takes as input flagged segment candidates, classifier outputs, and unified timeline records, and outputs element information records.

The server aggregates rule evidence, classifier category predictions, probability values, and the specific tokens and labels that contributed to the decision, formats this data into structured entries, and stores an element information record that links segment identifier, time interval, issue type, and evidence components.

### Step 10

The server constructs descriptive segment summaries to be embedded into a prompt sentence for a generative AI model.

The server takes as input element information records and unified timeline records and outputs human-readable segment descriptions.

The server formats each segment's time interval into a textual timecode, concatenates the list of relevant visual labels and transcript snippets, attaches classifier scores and issue types, and produces text lines such as “Segment 00:01:23-00:01:29: visual labels [A, B, C], transcript [‘ ’], category [violent scene, 0.92].”

### Step 11

The server generates a prompt sentence to instruct the generative AI model to produce explanations and editing proposals.

The server takes as input segment descriptions and system context information and outputs a complete prompt sentence.

The server selects a prompt template according to the target audience or policy, inserts instructions specifying tasks to identify inappropriate scenes and propose editing options, embeds the segment descriptions into the prompt body, and concatenates these components into a coherent block of natural-language text.

### Step 12

The server transmits the prompt sentence to the generative AI model and receives response information.

The server takes as input the prompt sentence and generative model parameters, and outputs response information containing explanations and editing proposals.

The server calls an inference endpoint of the generative AI model, sends the prompt sentence along with settings such as maximum tokens and temperature, waits for the model to generate text, receives the generated text, and stores the raw response together with a reference to the corresponding content identifier.

### Step 13

The server parses the response information from the generative AI model into structured editing suggestions.

The server takes as input the raw generated text and known segment identifiers, and outputs structured editing suggestion records.

The server analyzes the generated text to identify references to time intervals, operation types, and explanations, extracts segment references and operation descriptions using pattern matching or simple parsing rules, maps described intervals to known segment identifiers, and creates editing suggestion entries that specify operation type, segment reference, and narrative explanation.

### Step 14

The server generates explanation information for presentation to the user.

The server takes as input element information records and structured editing suggestion records and outputs explanation entries for a user interface.

The server combines classifier evidence and generative model explanations, constructs concise sentences that reference specific labels and tokens, associates each explanation with its respective segment and operation proposals, and stores these explanations in a form ready to be sent to the terminal.

### Step 15

The terminal requests and receives analysis results and explanations from the server.

The terminal takes as input a content identifier and user request actions, and outputs a rendered display of flagged segments and explanations.

The terminal sends a query to the server with the content identifier, receives a payload containing explanation entries and editing suggestions, renders a timeline or list view that includes timecodes, descriptions of issues, and suggested edits, and displays this information to the user.

### Step 16

The user reviews flagged segments and selects preferred editing options on the terminal.

The user takes as input the displayed explanations and video previews and outputs explicit editing selections.

The user interacts with user interface controls such as checkboxes or buttons corresponding to operations like deletion, masking, or audio muting for each segment, and confirms a set of desired operations for generating edited candidates.

### Step 17

The terminal transmits the user's editing operation information to the server.

The terminal takes as input the user's selections and the associated content identifier, and outputs an HTTPS request containing editing operation information.

The terminal encodes each selected operation type and target segment into a structured payload, attaches the payload to a request addressed to the server, and sends the request over the network.

### Step 18

The server converts the user-selected operations and model suggestions into an editing operation sequence.

The server takes as input editing suggestion records and user editing operation information and outputs an optimized editing operation sequence.

The server reconciles model proposals with user selections, removes operations that the user has rejected, merges overlapping or adjacent operations, determines an execution order that minimizes decoding and encoding passes, and stores the resulting sequence as a list of operations with precise time intervals and parameters.

### Step 19

The server executes media editing using the editing operation sequence to generate multiple edited candidates.

The server takes as input the original media file and the editing operation sequence and outputs edited media files as candidates.

The server configures a media processing engine with filters and options corresponding to the operations, invokes the engine to decode the original media, applies filters such as trimming, blurring, masking, and volume adjustment at specified time intervals, encodes the processed frames and audio into new media files, and writes each candidate file to storage with associated metadata.

### Step 20

The server notifies the terminal of the availability of edited candidates and provides references to them.

The server takes as input the set of generated edited media files and outputs candidate descriptors for the terminal.

The server creates records that map candidate identifiers to file locations and applied operations, constructs a response including these identifiers, durations, and preview references, and transmits the response to the terminal.

### Step 21

The terminal obtains previews of edited candidates and presents them to the user.

The terminal takes as input candidate descriptors and outputs a user interface that enables candidate comparison.

The terminal requests preview streams or thumbnails from the server, decodes received preview data, displays each candidate with visual indicators of edited regions, and provides playback controls for the user to view the different versions.

### Step 22

The user selects a final edited version of the time-series media information.

The user takes as input the displayed previews of candidates and outputs a final selection.

The user compares visual appearance and audio of the candidates, determines which candidate best satisfies content and policy requirements, and confirms one candidate as the final version by operating a selection control in the interface.

### Step 23

The terminal transmits final selection information to the server.

The terminal takes as input the user's candidate choice and outputs a selection notification to the server.

The terminal packages the chosen candidate identifier and the associated content identifier, sends a request to the server indicating that this candidate should be treated as final edited time-series media information, and waits for acknowledgment.

### Step 24

The server marks the selected candidate as final and prepares it for distribution.

The server takes as input the chosen candidate identifier and outputs a finalized edited media reference.

The server updates database records to mark the candidate as final, optionally re-encodes the file into a standardized output format if necessary, stores the final file in a designated storage location, and generates a stable access path such as a URL or storage key for downstream use.

### Step 25

The server provides the final edited media reference to the terminal for further use.

The server takes as input the final media reference and outputs response data containing publication information.

The server transmits a response indicating the final file location, file properties, and any relevant metadata to the terminal, enabling the user to download the file or instruct another service to publish it.

### Step 26

The server logs processing details for technical improvement and future model training.

The server takes as input operation results, classifier outputs, generative model responses, and user selections, and outputs log entries stored for later analysis.

The server writes structured records that capture feature statistics, detection outcomes, prompt sentences, generated responses, editing operation sequences, and user feedback, and later uses these records to refine rules, retrain classifiers, adjust prompt templates, and optimize processing pipelines, thereby improving detection accuracy and processing efficiency over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content moderation and editing workflows for user-generated digital content, such as video and audio content to be posted on a network platform, suffer from several technical limitations in how computing resources process, structure, and act upon multimodal data. In many existing systems, inappropriate elements are detected either manually by human reviewers or by simple rule-based filters operating separately on visual data or audio data. Such systems typically fail to generate coherent, time-aligned representations of problematic content across modalities, and they do not convert detection results into machine-usable structures that can drive automated editing pipelines in a reliable and reproducible manner. As a result, the processor cannot efficiently orchestrate end-to-end processing from detection to editing within a single integrated system.

First, when a processor handles visual information and audio information of digital content independently, the processor often lacks a unified temporal model that correlates visual events (such as appearance of certain objects or scenes) with audio events (such as utterance of specific phrases). This results in fragmented detection outputs that are not normalized into consistent intervals with explicit start and end times. Without such normalized, integrated detection result data, it is technically difficult for the processor to perform precise editing operations, such as cutting, masking, or muting, because the editing pipeline cannot accurately determine which exact time ranges and which data streams (video or audio) should be modified.

Second, existing systems that use machine learning or generative models tend to employ them in an ad hoc or opaque fashion. For example, a generative model may be asked broadly to “clean” the content, but the system does not generate structured prompt sentences that encode detection metadata, content policy constraints, and contextual information in a machine-readable form. Consequently, the interaction between the deterministic detection pipeline (e.g., frame-level analysis and speech recognition) and the generative model is loosely coupled and not optimized at the processor level. This hinders the ability of the processor to obtain reliable, actionable editing instructions from the generative model and to map such instructions to concrete operations of video and audio processing components.

Third, many user interfaces for content editing merely present raw detection flags or simple warnings to a user, leaving the user to perform complex manual edits using generic editing tools. The processor in such systems does not generate multiple alternative edited content candidates in an automated manner, nor does it present them in a way that optimizes user interaction and reduces user burden. Furthermore, the processor generally does not learn from user interaction histories and reaction information to adjust the order or content of editing proposals, leading to inefficient and non-adaptive user experiences. This represents a technical shortcoming in how the system structures and utilizes user feedback data to improve subsequent processing.

Fourth, existing pipelines rarely integrate detection reasons into a coherent natural language explanation that is both human-readable and tightly coupled with the underlying detection metadata. The absence of such explanations, generated systematically from integrated detection result data and generative model responses, limits transparency and debuggability of the moderation and editing process, and prevents the processor from providing explanatory feedback that can guide user decisions and future system tuning.

Accordingly, there is a need for a computer-implemented technique in which a processor (i) systematically segments and integrates visual and audio detection results into unified, time-stamped data structures; (ii) generates structured prompt sentences that encode this integrated detection result data and content providing conditions, and supplies such prompts to a generative information processing model; (iii) converts responses from the generative information processing model into machine-readable editing candidate data that directly drive automated video and audio editing; and (iv) presents multiple edited content candidates and natural language explanations to a user via an interactive display interface while adaptively adjusting the presentation based on user operation history and reaction information. By addressing these aspects as a coordinated data-processing architecture, the invention aims to improve the functioning of the computer system itself in terms of how it represents, transforms, and acts upon multimodal digital content for moderation and editing purposes.

The specific processing by the specific processing unit 290 of the data processing device 12 in Application Example 1 is realized by the following means.

The present invention provides a server comprising a processor configured to obtain visual information and audio information of digital content to be posted and divide the visual information and the audio information into analysis target data for each unit time based on time information, to analyze the visual information by using an image processing program and a discrimination information processing model to determine an object, an action, and a scene, and generate first detection result data indicating an element that has a possibility of being inappropriate, to analyze the audio information by using a speech recognition program to convert the audio information into character string data, analyze the character string data by using a text classification information processing model or a rule set, and generate second detection result data indicating an expression that has a possibility of being inappropriate, to integrate the first detection result data and the second detection result data based on the time information and generate integrated detection result data which, for each interval of the digital content that has a possibility of being inappropriate, includes a start time, an end time, a type of a corresponding element, and a detection reason, to generate a structured prompt sentence based on the integrated detection result data and analysis context data including a content providing condition so as to instruct a generative information processing model to generate an editing method for the element that has a possibility of being inappropriate, to analyze response data acquired from the generative information processing model and generate editing candidate data representing a plurality of editing plans, each editing plan including a specific editing operation procedure such as deletion, masking, audio removal, or alternative information superimposition for each interval that has a possibility of being inappropriate, to present the editing candidate data, together with time information, an editing type, and an outline of an editing result, via a user operation display interface and acquire a selection operation of an editing plan from a user, to execute video signal processing and audio signal processing on the digital content based on the editing plan corresponding to the selection operation acquired from the user and generate edited digital content data and store the edited digital content data in a storage device, to generate, based on the detection reason included in the integrated detection result data and the response data acquired from the generative information processing model, an explanation sentence in natural language for each element that has a possibility of being inappropriate and present the explanation sentence via the user operation display interface, and to adjust a presentation order or contents of the editing candidate data based on an operation history and reaction information of the user. This enables the computer system to implement an integrated multimodal content moderation and editing pipeline in which time-synchronized detection results are transformed into structured prompts for a generative model, the generative model's responses are converted into executable editing plans, multiple edited content candidates and associated explanations are automatically generated and presented to the user, and the overall processing and user interaction behavior are adaptively optimized based on accumulated user interaction data.

The term “digital content” refers to information encoded in an electronic format, including at least one of visual information, audio information, or a combination thereof, such as video data, image data, or audio data intended to be posted or distributed via an information processing system.

The term “visual information” refers to data representing an image or a sequence of images, including video frames or still images, that can be processed by an image processing program or a discrimination information processing model.

The term “audio information” refers to data representing sound, including speech, music, or other audio signals, that can be processed by a speech recognition program or an audio signal processing component.

The term “time information” refers to data indicating temporal positions or intervals within digital content, including timestamps, frame indices, or time codes used to correlate visual information and audio information.

The term “analysis target data” refers to segmented units of visual information and audio information that are divided based on time information, and that are used as inputs for subsequent analysis processing.

The term “image processing program” refers to software that performs computational operations on visual information, including at least one of frame extraction, region-of-interest detection, filtering, feature extraction, or object detection.

The term “discrimination information processing model” refers to a data processing model, such as a machine learning model or rule-based model, that classifies or recognizes objects, actions, scenes, or other attributes from visual information.

The term “speech recognition program” refers to software that analyzes audio information and converts it into character string data representing recognized words, phrases, or sentences.

The term “character string data” refers to textual data obtained by converting audio information into sequences of characters, including words, phrases, and sentences, suitable for further text-based analysis.

The term “text classification information processing model” refers to a data processing model that assigns one or more categories or labels to character string data, for example to determine whether the content is inappropriate, offensive, or policy-violating.

The term “rule set” refers to a collection of predefined conditions, patterns, or logical expressions that are applied to character string data to detect specific expressions, keywords, or phrase structures indicating potentially inappropriate content.

The term “first detection result data” refers to structured data generated from analysis of visual information by the image processing program and the discrimination information processing model, indicating elements in the visual information that have a possibility of being inappropriate and including at least one of element type, location, time, and confidence. The term “second detection result data” refers to structured data generated from analysis of audio information and character string data by the speech recognition program and the text classification information processing model or the rule set, indicating expressions in the audio information that have a possibility of being inappropriate and including at least one of expression type, time, and confidence.

The term “integrated detection result data” refers to structured data obtained by integrating the first detection result data and the second detection result data based on time information, the structured data including, for each interval of the digital content that has a possibility of being inappropriate, a start time, an end time, a type of a corresponding element, and a detection reason.

The term “detection reason” refers to information that explains why a particular element or interval was determined to have a possibility of being inappropriate, including at least one of detected object types, detected expressions, model outputs, rule matches, or policy references. The term “content providing condition” refers to one or more constraints or requirements regarding how digital content is to be provided or published, including, for example, target audience, safety level, platform policy, or legal compliance criteria.

The term “analysis context data” refers to data that includes the integrated detection result data and the content providing condition, and that is used to construct a prompt sentence for a generative information processing model.

The term “prompt sentence” refers to a structured input, including at least natural language text and optionally structured fields, that is generated based on the integrated detection result data and the analysis context data, and that instructs a generative information processing model to generate an editing method for elements that have a possibility of being inappropriate.

The term “generative information processing model” refers to an information processing model, such as a generative artificial intelligence model, that generates output information including text or other representations in response to a prompt sentence, and that can propose editing methods for digital content.

The term “response data” refers to data returned by the generative information processing model in response to the prompt sentence, the data including proposed editing methods, rationales, or other instructions with respect to elements that have a possibility of being inappropriate.

The term “editing candidate data” refers to structured data representing a plurality of editing plans derived from the response data, each editing plan including specific editing operation procedures for corresponding intervals of the digital content.

The term “editing plan” refers to a set of one or more editing operations, each editing operation being defined with respect to at least a time interval, an editing type, and parameters necessary for execution of video signal processing or audio signal processing. The term “editing operation procedure” refers to a description of how to modify digital content, including operations such as deletion, masking, blurring, cropping, audio removal, muting, or overlaying alternative information.

The term “deletion” refers to an editing operation procedure that removes a time interval or a portion of visual information or audio information from the digital content.

The term “masking” refers to an editing operation procedure that obscures or replaces a region of visual information or a portion of audio information so that the original content is not recognizable.

The term “audio removal” refers to an editing operation procedure that attenuates, mutes, or replaces audio information in a specified time interval of the digital content.

The term “alternative information superimposition” refers to an editing operation procedure that overlays substitute visual or audio information, such as text, images, or signals, over an interval or region of the original digital content.

The term “editing type” refers to a classification of an editing operation, including but not limited to deletion, masking, blurring, cropping, audio muting, or overlaying substitute content.

The term “editing result outline” refers to summary information that describes, in a condensed form, how the digital content will be modified by a particular editing plan or editing operation.

The term “user operation display interface” refers to a graphical or interactive user interface rendered on a terminal, through which a user can view editing candidate data, explanation sentences, and edited content candidates, and can provide selection operations or other inputs.

The term “selection operation” refers to an input action by a user, received via the user operation display interface, that indicates a choice of one or more editing plans or edited content candidates.

The term “video signal processing” refers to processing operations performed on visual information of digital content, including at least cutting, concatenating, filtering, masking, or overlaying visual elements.

The term “audio signal processing” refers to processing operations performed on audio information of digital content, including at least muting, filtering, mixing, replacing, or adjusting volume of audio signals.

The term “edited digital content data” refers to digital content data that has been modified by video signal processing and audio signal processing according to a selected editing plan, resulting in a version in which elements that have a possibility of being inappropriate are mitigated or removed.

The term “storage device” refers to a hardware component or system that stores digital data, including at least one of a magnetic storage medium, a semiconductor memory, or a network-based storage resource.

The term “explanation sentence” refers to a natural language sentence or set of sentences generated based on the detection reason and the response data from the generative information processing model, and explaining to a user why an element or interval is considered to have a possibility of being inappropriate or how it is proposed to be edited. The term “operation history” refers to data indicating past operations performed by a user through the user operation display interface, including selections of editing plans, navigation actions, confirmations, or cancellations.

The term “reaction information” refers to data representing user responses or behaviors in relation to presented editing candidate data or edited content candidates, including but not limited to selection frequencies, dwell times, rejection patterns, or explicit feedback.

The term “presentation order or contents of the editing candidate data” refers to at least one of the sequence, grouping, filtering, or formatting of editing candidate data as shown on the user operation display interface, which may be adjusted based on the operation history and the reaction information.

In one embodiment, a server, a terminal, and a user cooperate to implement a multimodal digital content moderation and editing system. The server includes at least one processor, a memory, a storage device, and a network interface. The terminal includes at least one processor, a display, an input device such as a touch panel or keyboard, and a communication interface. The user operates the terminal to upload digital content, review proposed edits, and select final editing plans.

The server executes a program stored in the memory to perform integrated processing of visual information and audio information contained in digital content. The server uses concrete software components, such as a video decoding tool (for example, FFmpeg), an image processing library (for example, an open-source image processing library), a speech recognition service (for example, a cloud-based speech-to-text service), a machine learning framework (for example, a neural network framework), and a generative AI model execution environment (for example, an API client for a generative AI model). The server runs on general-purpose computing hardware, such as a multi-core central processing unit, a graphics processing unit used for neural network inference, and a persistent storage subsystem such as a disk array or a networked storage service.

The server acquires digital content data from the terminal. The server stores the digital content, such as a compressed video file including both visual information and audio information, in the storage device. The server uses the video decoding tool to generate a sequence of frames from the visual information and to extract an audio track from the audio information. The server stores the frames as image data and stores the audio track as an audio file in the storage device. The server associates each frame and each portion of the audio track with time information such as timestamps or frame indices.

The server uses the image processing library to load the frames into memory and to perform normalization and resizing operations on the frames. The server uses a discrimination information processing model implemented as a convolutional neural network to detect objects, actions, and scenes in the frames. The server configures the convolutional neural network with a plurality of convolutional layers, pooling layers, non-linear activation layers, and fully connected layers. The server loads pretrained weight parameters from the storage device into the memory, where the parameters have been obtained by supervised learning on training image data that includes labels for potentially inappropriate visual elements such as weapons, graphic violence, nudity, or sensitive symbols.

The server feeds each normalized frame into the convolutional neural network. The server obtains, for each frame, a set of feature maps and classification scores. The server calculates bounding box coordinates and class probabilities using algorithms such as anchor-based object detection or region proposal methods. The server compares the class probabilities with predetermined thresholds that are stored as configuration data in the memory. The server generates first detection result data containing, for each frame or frame group, identifiers of detected element types, temporal positions, spatial coordinates, and confidence scores. The server stores the first detection result data in a structured data format, such as a table or list indexed by time.

The server uses the speech recognition service to convert the audio file into character string data. The server configures parameters such as sampling rate, language code, and recognition mode. The server sends chunks of the audio file to the speech recognition service over a secure network connection and receives transcription results as structured text. The server aligns the transcription results with time information, such as start and end times for each word or phrase, and stores the character string data and associated time information in the storage device as raw transcript data.

The server uses a text classification information processing model, implemented for example as a recurrent neural network or a transformer-based neural network, to analyze the character string data. The server represents the text as sequences of tokens. The server converts tokens to embedding vectors using an embedding matrix stored in the memory. The server forwards the embeddings through neural network layers that may include attention mechanisms, recurrent units, or feedforward layers. The server computes class probabilities indicating whether a given sentence or phrase contains profanity, hate speech, sexual content, or other categories of inappropriate content. The server optionally combines the neural network output with a rule set that specifies regular expressions, keyword lists, and phrase patterns that indicate disallowed expressions.

The server compares output probabilities with threshold values and applies the rule set to detect particular expressions. The server generates second detection result data containing, for each time interval of the transcript, the type of inappropriate expression, the probability score, and the matched rules if any. The server stores the second detection result data in a structured data format, aligned with the time information.

The server integrates the first detection result data and the second detection result data based on time information. The server groups contiguous time intervals where visual inappropriate elements and audio inappropriate expressions occur. The server merges overlapping intervals to form unified intervals. The server assigns, for each unified interval, a set of element types, a start time, an end time, and at least one detection reason. The detection reason includes information such as “object type X detected in region Y with confidence Z” or “text segment contains profanity with probability P and matches rule R.” The server generates integrated detection result data containing a record for each unified interval. The server stores this integrated detection result data in the storage device as a machine-readable structure.

The server generates analysis context data that includes the integrated detection result data and content providing conditions. The content providing conditions may specify target audience categories such as children or general users, platform safety levels, or jurisdictional regulations. The server stores the content providing conditions in a configuration module and retrieves them for each digital content item.

The server generates a prompt sentence for a generative AI model. The server uses a prompt construction module implemented as program code that formats the integrated detection result data and the content providing conditions into natural language and structured instructions. The server includes, in the prompt sentence, descriptions of intervals, detected visual elements, transcript snippets, and applicable policies. An example of such a prompt sentence is:
“You are assisting in making a children-friendly video. The following segment has been detected as potentially inappropriate: 00:03:00-00:03:08. Visual: cartoon characters fighting with weapon-like objects in the center of the screen. Audio transcript: ‘I'm going to crush you for real.’ Policy: no realistic violence, no threats, and no aggressive language in content for children. Please propose at least two concrete editing options for this segment (for example, cut, blur, crop, mute audio, or replace with a neutral placeholder). For each option, provide a brief rationale and describe the edits in a way that can be implemented with tools such as a video processing program and an audio processing program.”

The server sends the prompt sentence to the generative AI model via an API interface. The server may use a generative AI model implemented as a large-scale neural network having multiple transformer layers, including self-attention mechanisms, feedforward sublayers, and normalization layers. The generative AI model parameters have been trained by gradient descent on large-scale text and instruction data. The server controls the generative AI model inference by specifying parameters such as maximum output length, temperature, and sampling method. The server receives response data from the generative AI model in the form of text that includes multiple alternative editing plans and rationales.

The server parses the response data to extract editing operation procedures. The server maps human-readable instructions into structured editing candidate data. For example, when the response data includes an instruction such as “Blur the entire frame from 00:03:00 to 00:03:08 and mute the audio while showing an overlay text ‘Scene removed for child safety’,” the server converts this into a structured record specifying a time interval, a video editing type (blur), a region (full frame), an audio editing type (mute), and an overlay instruction (display specified text). The server repeats this mapping for each proposed editing plan and each relevant interval.

The server stores the editing candidate data as a data structure that associates each interval with multiple editing plans, each editing plan including editing types and parameters. The server prepares editing result outlines for each editing plan, describing how the content will be modified. The server sends the editing candidate data and the outlines to the terminal via the network interface.

The terminal receives the editing candidate data and displays it to the user through a user operation display interface. The terminal shows, for each detected interval, the time range, a summary of the reason for detection, and multiple editing options such as “cut this scene,” “blur this region,” “mute this audio,” or “apply overlay text.” The terminal may display preview thumbnails for visual edits or short audio previews for audio edits. The user selects one of the options for each interval or selects a combination of editing plans corresponding to full edited content candidates.

The terminal sends the selection operation information to the server. The server validates the received selection against the stored editing candidate data. The server then performs video signal processing and audio signal processing according to the selected editing plan. The server uses the video decoding tool and the image processing library to cut, concatenate, blur, crop, or overlay visual elements. The server uses audio processing functions to mute, filter, or replace audio segments. The server executes these operations using a defined pipeline that operates on time-aligned media segments. The server thereby generates edited digital content data, such as a new video file.

The server stores the edited digital content data in the storage device and updates metadata linking the edited version to the original digital content. The server may generate multiple edited digital content candidates corresponding to different combinations of editing plans (for example, one version with all cuts, another with masking, and another with audio muting only). The server sends identifiers and access paths of the edited digital content candidates to the terminal. The terminal presents the multiple edited digital content candidates in parallel, allowing the user to preview and select a final version in real time.

The server generates explanation sentences in natural language for each inappropriate element. The server uses the detection reasons from the integrated detection result data and portions of the response data from the generative AI model. The server constructs explanation sentences such as “This interval contains a weapon-like object and aggressive language, which violates the children's safety policy.” The server sends these explanation sentences to the terminal to assist the user in understanding why specific edits are proposed. The server adjusts the presentation order or content of the editing candidate data based on operation history and reaction information. The server stores user interaction logs in the storage device, including which editing plans are frequently selected, which proposals are often rejected, and how much time the user spends on each proposal. The server uses these logs to compute preference scores or adaptively re-rank future editing candidate data. For example, if a user or a group of users consistently chooses “blur and mute” over “cut,” the server may place blur-and-mute options first in the presentation order. This adaptive behavior improves the efficiency of user interaction and reduces unnecessary screen updates and network traffic.

The server improves computer technology in multiple ways. The integrated detection result data structure, which unifies multimodal detections over time, reduces redundant computations when applying edits and enables precise time-based operations, thereby improving processing efficiency and reducing errors in editing. The explicit mapping from detection outputs to prompt sentences and from generative responses to executable editing plans creates a reproducible transformation chain that can be optimized. The server can cache intermediate detection results and reuse them, which reduces processing load for re-analyses of the same or similar content.

The use of specialized neural network architectures for visual and textual analysis allows the server to achieve higher detection accuracy than simple rule-based filters. By training the convolutional neural network and the text classification neural network with loss functions such as cross-entropy and using optimization algorithms such as stochastic gradient descent with momentum or adaptive moment estimation, the server learns to distinguish subtle patterns that human operators would find difficult to systematically encode. The server may use data augmentation techniques for training, such as random cropping, rotation, color jittering for images, and noise injection or time stretching for audio transcripts, which improves robustness of the models and reduces misclassification rates.

The generative AI model, configured as a transformer-based architecture, is trained via supervised fine-tuning and reinforcement learning from human feedback or other preference signals to produce editing proposals that are not simple repetitions of pre-programmed rules. The server uses embedding layers, multi-head self-attention, and position encoding to handle long and complex prompt sentences that describe multimodal intervals and policy constraints. The server benefits from this model because the model generates coherent multi-step editing strategies that coordinate video and audio modifications, which are not trivial for a human editor to design consistently at scale.

The server's data structures, including the integrated detection result data, the analysis context data, and the editing candidate data, are specifically designed to support low-latency, incremental updates. The server can compute and store partial results for early time intervals of the content while later intervals are still being processed. This streaming-like processing reduces user waiting time and spreads computational load over time, improving throughput and resource utilization in the server.

The server thereby does more than merely automate human review. The server restructures raw multimedia streams into a machine-optimized multimodal representation, couples deterministic analysis pipelines with generative editing synthesis via structured prompt sentences, and closes the loop with adaptive user-interface optimization based on measured interaction data. This architecture brings about technical effects such as reduced end-to-end latency from upload to final edited output, improved accuracy in localizing inappropriate content, reduced number of manual correction steps, and lower overall computational and network overhead due to reuse and optimization of intermediate representations.

Alternative embodiments are possible. The server may implement different neural network architectures, such as a three-dimensional convolutional neural network for spatiotemporal video analysis, or a bidirectional encoder model for transcript classification. The server may use different types of generative AI models, such as a smaller or larger transformer, depending on resource constraints. The terminal may be a mobile device, a personal computer, or a specialized editing workstation. The speech recognition program may run locally on the server or may be provided by an external service. The discrimination information processing model and the text classification information processing model may share feature extractors or embeddings to reduce memory and computation usage. In another embodiment, the server uses a rule-based pre-filter to identify obviously safe or obviously unsafe content and reserves the generative AI model for borderline cases. This hybrid approach reduces load on the generative AI model and shortens processing time for most content. In yet another embodiment, the server records the generative AI model's editing suggestions and the user's final choices and uses this data as feedback for further fine-tuning of the text classification thresholds or prompt construction strategies. In this manner, the server incrementally improves its internal models and heuristics over time, further enhancing the technical performance of the overall system.

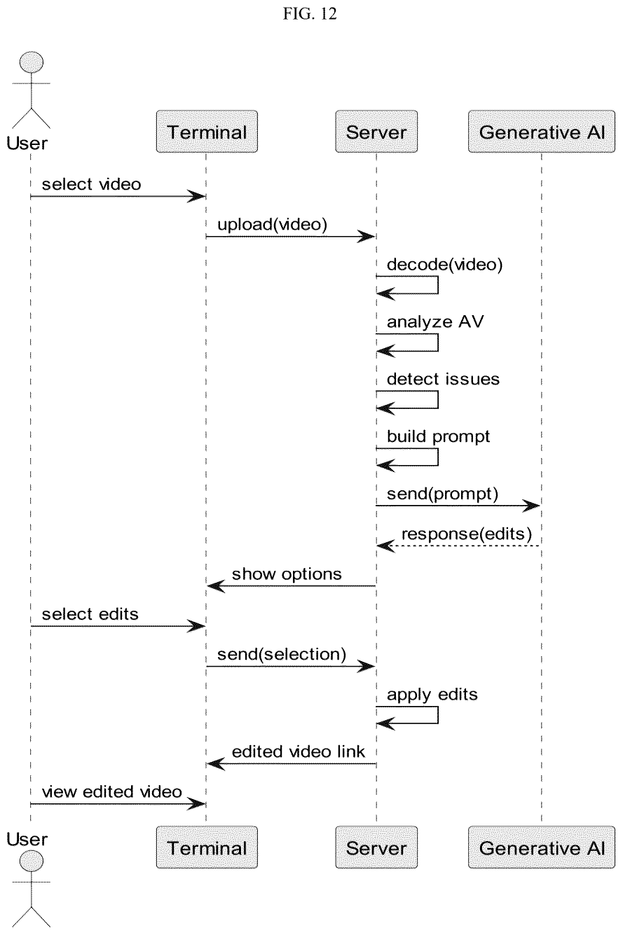

The following describes the processing flow using FIG. 12.

### Step 1

Server receives digital content and stores raw data.

Server receives, from the terminal, an upload request including a digital content file (input) and associated metadata such as title and target audience. Server writes the digital content file to a storage device and registers a content identifier, a file path, and the metadata in a management database (output). Server thereby converts an incoming network data stream into a persistent media object record that can be referenced in subsequent processing.

### Step 2

Server decodes digital content into visual frames and an audio track.

Server reads the stored digital content file (input) and invokes a video decoding program to separate the file into a sequence of visual frames and a single audio track (output). Server performs data conversion from compressed video format into uncompressed or lightly compressed image data for each frame, and from multiplexed media format into a linear audio waveform file. Server assigns time information, such as timestamps or frame indices, to each frame and audio segment.

### Step 3

Server segments visual and audio data into unit-time analysis targets.

Server takes the time-stamped frames and audio waveform (input) and divides them into analysis target data for each unit time, such as one-second or half-second intervals (output). Server groups frames that fall within the same time interval and segments the audio waveform into corresponding chunks. Server generates a structured list in which each entry represents an analysis unit containing a set of frames, an audio chunk, and a time range.

### Step 4

Server analyzes visual information with an image processing library and a discrimination model.

Server uses the grouped frames for each analysis unit (input) and loads them into an image processing library. Server normalizes resolution and color channels, then forwards the processed frames to a discrimination information processing model, such as a convolutional neural network (output: first detection result candidates). Server executes convolution, pooling, and activation operations to compute feature maps and classification scores for objects, actions, and scenes. Server applies a detection algorithm to obtain element types, bounding boxes, and confidence scores, and stores these as first detection result data associated with the corresponding time intervals.

### Step 5

Server extracts and preprocesses audio for speech recognition.

Server uses the segmented audio chunks for each analysis unit (input) and resamples them to a required format, such as mono audio at a specific sampling rate (output: normalized audio chunks). Server adjusts bit depth and encodes audio into a format accepted by a speech recognition program. Server updates the analysis unit records to point to these normalized audio chunks for subsequent recognition.

### Step 6

Server performs speech recognition and generates character string data.

Server inputs the normalized audio chunks (input) into a speech recognition program that outputs recognized text and timestamps (output: raw transcript segments). Server performs acoustic modeling and language modeling internally to convert waveform features into token sequences, and produces, for each chunk, character string data with start and end times and confidence scores. Server stores these transcript segments in association with the corresponding time intervals.

### Step 7

Server classifies textual content and detects inappropriate expressions.

Server reads the transcript segments with time information (input) and passes the text through a text classification information processing model and a rule set (output: second detection result data). Server tokenizes the text, generates embedding vectors, and processes them through neural network layers to produce category probabilities. Server compares these probabilities with predefined thresholds and applies pattern-matching rules to detect profanity, hate speech, sexual content, or other disallowed expressions. Server generates structured second detection result data indicating expression type, time interval, and confidence.

### Step 8

Server integrates visual and audio detection results into unified intervals.

Server accesses the first detection result data and the second detection result data (input) and merges them based on time information (output: integrated detection result data). Server aligns overlapping time ranges, groups contiguous detections, and resolves conflicts by applying priority rules across categories. Server, for each unified interval, assigns a start time, an end time, a combined set of element types, and at least one detection reason derived from the underlying detections. Server writes this integrated detection result data as a normalized multimodal representation.

### Step 9

Server constructs analysis context data including content providing conditions.

Server reads the integrated detection result data and content providing conditions (input), such as target audience and platform safety requirements, and aggregates them into analysis context data (output). Server formats the context data as a structured object listing, for each interval, the element types, severity, policy references, and time ranges. Server stores this analysis context data to be used for generating a prompt sentence for a generative AI model.

### Step 10

Server generates a prompt sentence for the generative AI model.

Server takes the analysis context data (input) and uses a prompt construction module to create a prompt sentence (output) that describes each potentially inappropriate interval and the applicable content providing conditions. Server embeds timestamp ranges, brief descriptions of visual detections, relevant transcript snippets, and policy constraints into natural language instructions. Server concatenates these descriptions into a single coherent prompt sentence that instructs the generative AI model to propose editing methods for the identified intervals.

### Step 11

Server sends the prompt sentence to the generative AI model and receives response data. Server supplies the generated prompt sentence (input) to a generative AI model via an API, specifying inference parameters such as maximum token count and sampling settings (output: response data). Server initiates remote or local inference, during which the generative AI model processes the prompt sentence with a neural network architecture, such as a transformer, and returns textual output that includes proposed editing plans and rationales. Server collects the response data and stores it for further processing.

### Step 12

Server parses response data and creates editing candidate data.

Server takes the response data from the generative AI model (input) and performs parsing operations to extract individual editing instructions and associated intervals (output: editing candidate data). Server identifies keywords that indicate editing types, such as deletion, masking, blurring, muting, or overlaying substitute content, and maps time references in the text back to the unified intervals. Server builds structured editing candidate data objects describing, for each interval, a plurality of editing plans, each plan containing specific operation parameters required for video and audio processing.

### Step 13

Server generates editing result outlines for user presentation.

Server uses the editing candidate data (input) and creates, for each editing plan, a concise editing result outline (output: annotated editing candidate data). Server summarizes the effect of each plan, such as “cut this 5-second scene,” “blur characters' faces,” or “mute all dialogue in this interval,” and attaches these summaries to the corresponding editing plans. Server prepares a data package that includes time information, editing types, and editing result outlines to send to the terminal.

### Step 14

Terminal displays editing candidate data and explanation sentences to the user. Terminal receives the annotated editing candidate data and explanation sentences from the server (input) and renders them on a user operation display interface (output: interactive display). Terminal lists intervals with their timestamps, detection reasons, and proposed editing options. Terminal may show visual markers on a timeline and textual descriptions, enabling the user to understand what part of the content will be changed and why.

### Step 15

User selects preferred editing plans via the terminal.

User views the displayed intervals and editing options (input) and performs selection operations by tapping, clicking, or otherwise interacting with the user operation display interface (output: user selection data). User may choose one editing plan per interval or select a preset combination that applies the same type of editing across multiple intervals. User confirms the choices by activating a submission control on the terminal.

### Step 16

Terminal sends user selection data to the server.

Terminal collects the user's selection operations (input) and constructs a message containing the selected editing plan identifiers, associated intervals, and the content identifier (output: selection message). Terminal transmits this message to the server over a network connection, thereby converting user interactions into machine-readable configuration data for the editing pipeline.

### Step 17

Server validates selections and configures an editing pipeline.

Server receives the selection message (input) and checks that each selected editing plan matches an existing candidate plan in the editing candidate data (output: validated editing configuration). Server resolves any conflicts or missing data, such as intervals without a selected plan, by applying default rules. Server converts the validated configuration into a sequence of low-level video and audio processing operations, including time-based segmenting, filter application, and track mixing instructions.

### Step 18

Server executes video signal processing according to the selected plans.

Server uses the validated editing configuration and the stored frames or original video stream (input) to perform video signal processing (output: processed visual stream). Server invokes image processing and video processing tools to cut or concatenate segments, apply blurring masks, crop regions, and overlay alternative visual information such as text banners. Server computes new frame sequences that reflect the selected edits, ensuring that timecodes remain consistent for synchronization with audio.

### Step 19

Server executes audio signal processing according to the selected plans.

Server uses the validated editing configuration and the stored audio track (input) to perform audio signal processing (output: processed audio stream). Server applies operations such as muting, volume reduction, insertion of beep tones, or replacement of segments with neutral audio. Server manipulates the audio waveform using time-based filters and mixing functions, maintaining alignment with the processed visual stream.

### Step 20

Server combines processed streams and generates edited digital content data.

Server takes the processed visual stream and processed audio stream (input) and multiplexes them into a single edited digital content file (output: edited digital content data). Server encodes the combined streams into a desired container format, updates metadata such as duration and codec information, and assigns a unique identifier to the edited file. Server stores the resulting edited digital content data in the storage device.

### Step 21

Server generates and updates operation history and reaction information.

Server records the selection message, the applied editing configuration, and basic usage metrics such as time spent reviewing options (input) as part of an operation history log (output: updated interaction records). Server analyzes these records to derive reaction information, including which editing types are frequently chosen or rejected. Server stores this information for use in subsequent sessions to reorder or filter editing candidate data presented to the user.

### Step 22

Server adjusts future presentation of editing candidate data based on user behavior.

Server uses the operation history and reaction information (input) to adjust internal ranking parameters for editing plans (output: updated presentation policy). Server increases priority scores for frequently selected editing types and decreases scores for rarely used ones. Server applies these scores when generating and sending future editing candidate data, thereby changing the default order or emphasis of options in the user interface to improve efficiency.

### Step 23

Server returns final edited content information to the terminal.

Server uses the edited digital content data and its identifier (input) to generate a response message containing a playback URL or file reference and summary of applied edits (output: delivery message). Server transmits this message to the terminal, enabling the terminal to access and display the final edited version.

### Step 24

Terminal presents the edited digital content to the user.

Terminal receives the delivery message (input) and updates the user operation display interface to show the edited digital content as available for preview or posting (output: playback display). Terminal retrieves the edited digital content from the server and plays it back to the user, allowing the user to verify that inappropriate elements have been addressed according to the selected editing plans.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content moderation and editing systems for user-generated digital content, such as video or audio-visual files, typically rely on rule-based detection, manual review, and fixed, pre-programmed editing operations. These systems suffer from several technical limitations in terms of computer technology.

First, conventional systems often perform coarse-grained analysis of digital content without tightly coupling temporal metadata with semantic analysis results. For example, visual labels and speech recognition results may be generated, but are not systematically linked to precise time segments in a machine-readable structure. As a result, subsequent editing processes have difficulty accurately and efficiently mapping detected problematic content to specific sections of the underlying media stream. This leads to redundant processing, unnecessary re-encoding, and increased computational load on server-side resources.

Second, many existing systems do not utilize generative AI models in a structured, time-aware manner. In particular, they do not generate prompt sentences that encode both content features and time-segmented information as an integrated input to a generative AI model. Without such structured prompt sentences, generative AI models cannot reliably produce editing plans that align with the exact temporal positions and types of potentially inappropriate sections. This causes inefficiencies, such as misaligned edits, repeated user corrections, and additional server-side processing cycles to repair or regenerate edited content.

Third, conventional workflows typically separate the detection of problematic content from the generation of multiple, alternative edited content candidates. Editing operations are often hard-coded (for example, simple deletion or global muting) and do not flexibly combine different editing methods such as removal, visual masking, and audio muting in a unified, programmatically controlled pipeline. This restricts the system's ability to generate multiple edited candidates optimized for different content policies or user preferences, and forces additional manual operations or external tools, resulting in fragmented processing and higher latency.

Fourth, user interaction is often limited to simple approval or rejection of a single edited version, without real-time, interactive selection among multiple candidates and without feedback from the user's emotional reaction. Systems that do not incorporate user feedback signals at a technical level cannot adapt their prompt generation or candidate generation conditions dynamically. This results in repeated editing cycles, increased network traffic, and excessive consumption of processing resources on the server due to multiple iterations of content analysis and editing.

Fifth, conventional architectures for content moderation and editing do not clearly integrate: (i) time-segmented feature extraction; (ii) structured prompt generation for a generative AI model; (iii) server-side programmatic editing using a data processing apparatus; and (iv) interactive client-side selection with real-time feedback. The absence of such integration prevents the system from efficiently converting high-level analysis results into concrete, low-level editing instructions that can be executed by media processing components such as encoders, decoders, and filters. This leads to suboptimal utilization of computing resources, increased processing latency, and limited scalability for large volumes of user-generated content.

Accordingly, there is a need for an improved computer-implemented system that (1) precisely associates content features with time-segmented sections of electronic content, (2) generates structured, natural-language prompt sentences for a generative AI model including time-based section information, (3) uses model outputs to automatically control a program-controlled data processing apparatus to generate multiple edited content candidates with different editing methods, and (4) interacts with a user terminal in real time to present candidates, collect user selections, and adjust future prompt generation and candidate generation conditions based on recognized emotional states of the user. Such improvements directly address inefficiencies and inaccuracies in conventional systems and provide a more effective and technically advanced content moderation and editing pipeline.

The specific processing by the specific processing unit 290 of the data processing device 12 in Example 2 is realized by the following means.

The present invention provides a server comprising a processor and a memory storing instructions which, when executed by the processor, cause the processor to acquire electronic content to be posted, analyze visual information and audio information constituting the electronic content based on time information to extract content features, specify sections that are potentially inappropriate based on the content features and the time information and record section information including a start time, an end time, and a type of inappropriateness for each of the sections, generate, in a natural language, a prompt sentence for a generative AI model based on the section information and a content summary of the electronic content, the prompt sentence instructing the generative AI model to perform editing processing to remove or modify the sections that are potentially inappropriate from the electronic content, input the prompt sentence and the section information to the generative AI model, obtain, from the generative AI model, information on a plurality of editing plans or a plurality of edited electronic content candidates, each of the editing plans or edited electronic content candidates applying at least two or more different editing methods to the sections that are potentially inappropriate, control a program-controlled data processing apparatus, based on the editing plans, to generate a plurality of edited electronic content candidates by removing the sections that are potentially inappropriate from the electronic content or by processing the sections by visual masking, audio muting, or a combination thereof, present the plurality of edited electronic content candidates to a user terminal, receive a candidate selected by a user and determine the selected edited electronic content as final electronic content for posting, and present, in a natural language, a reason for specifying the sections that are potentially inappropriate to the user, recognize an emotional state of the user based on a reaction of the user, and adjust the prompt sentence or generation conditions of the plurality of edited electronic content candidates according to the emotional state. This enables the server to implement an integrated, time-segment-aware content analysis and editing pipeline that leverages generative AI models through structured prompt sentences, automatically controls low-level media processing operations to generate multiple edited content candidates with different editing methods, and dynamically optimizes subsequent prompt generation and candidate generation conditions based on real-time user interaction and emotional feedback, thereby improving the technical efficiency, accuracy, and scalability of computer-implemented content moderation and editing.

The term “electronic content” refers to machine-readable data representing media, including at least visual information, audio information, or a combination thereof, such as video data, image data, audio data, or multimedia data, that is processed or stored by a computing device.

The term “visual information” refers to data representing images or video frames, including color, brightness, pixel values, shapes, objects, scenes, or other graphical features that can be decoded and analyzed by a computing device.

The term “audio information” refers to data representing sound, including speech, music, ambient noise, or other acoustic signals, that can be decoded, played back, or analyzed by a computing device.

The term “time information” refers to timing-related data associated with electronic content, including timestamps, time indices, durations, or time segment boundaries that indicate positions or intervals within a media stream.

The term “content features” refers to attributes extracted from electronic content by analysis processing, including but not limited to detected objects, scenes, actions, speech transcripts, labels, categories, or other semantic or statistical descriptors associated with specific time information.

The term “section” refers to a portion of the electronic content defined by a time range between a start time and an end time, and optionally associated with one or more content features or types of inappropriateness.

The term “section information” refers to structured data describing a section, including at least a start time, an end time, and optionally a type of inappropriateness, labels, confidence scores, or other metadata.

The term “potentially inappropriate” refers to a state in which a section of electronic content is determined, based on predefined rules or criteria, to possibly include content that is violent, offensive, unsafe, or otherwise undesirable for a target usage or audience.

The term “type of inappropriateness” refers to a classification associated with a potentially inappropriate section, including categories such as violent content, offensive language, explicit imagery, hateful expression, or other defined policy categories.

The term “generative AI model” refers to a computational model implemented in software and/or hardware that has been trained using machine learning techniques to generate data or instructions, including but not limited to text, images, video, or editing plans, in response to an input such as a prompt sentence.

The term “prompt sentence” refers to a natural-language or structured-language instruction string provided as input to a generative AI model, which describes a task, conditions, constraints, or desired outputs, and which may include content features, time information, and editing requirements.

The term “editing plan” refers to structured information indicating how to modify electronic content, including at least one time-based operation such as cutting, masking, muting, or replacing content within specified sections.

The term “edited electronic content candidate” refers to a version of the electronic content that has been modified according to at least one editing plan, such that at least one potentially inappropriate section has been removed, masked, muted, or otherwise altered.

The term “editing method” refers to a type of processing operation applied to a section of electronic content, including but not limited to removal of the section, visual masking or blurring, audio muting or attenuation, or any combination thereof.

The term “program-controlled data processing apparatus” refers to a hardware and software arrangement, including at least one processor and memory, that executes program instructions to perform operations on electronic content, such as decoding, encoding, cutting, filtering, masking, or re-encoding media streams.

The term “user terminal” refers to an endpoint device operated by a user, including a computing device such as a smartphone, tablet, personal computer, or display-equipped communication device, configured to present information and receive user input.

The term “final electronic content” refers to an edited version of the electronic content that has been selected or confirmed for posting or distribution, after application of at least one editing method to potentially inappropriate sections.

The term “content summary” refers to descriptive data representing an overview of the electronic content, including for example a textual description, key labels, representative scenes, or condensed metadata that characterizes the content as a whole.

The term “reaction of the user” refers to observable or measurable user behavior in response to presented information, including but not limited to explicit inputs such as selections, confirmations, or rejections on a user interface, and optionally implicit signals such as interaction patterns or response timing.

The term “emotional state” refers to an inferred or recognized affective condition of a user, such as satisfaction, dissatisfaction, confusion, or concern, determined based on the reaction of the user and optionally additional interaction signals.

The term “generation conditions” refers to parameters or constraints used when generating prompt sentences or edited electronic content candidates, including but not limited to the number of candidates, strictness level of filtering, types of editing methods to apply, or prioritization rules for preserving or removing content.

The term “interactive display screen” refers to a user interface rendered on a user terminal that simultaneously presents information and receives user input, including graphical elements such as lists, thumbnails, buttons, or playback controls that allow a user to select or manipulate edited electronic content candidates.

The term “summary information” refers to condensed descriptive data for each edited electronic content candidate, including for example a title, a textual explanation of applied editing methods, affected time ranges, or key differences among candidates.

The term “reduced-size image” refers to a smaller or lower-resolution visual representation derived from a frame or portion of electronic content, such as a thumbnail, that is suitable for quick display and selection in a user interface.

The term “short-time playback information” refers to a preview segment of electronic content, such as a short clip or animated sequence, generated from an edited electronic content candidate for the purpose of quick review by a user.

The term “real time” refers to processing and communication behavior in which the system transmits, receives, and responds to user operations with latency that is sufficiently low for the user to perceive the interaction as immediate or substantially immediate during normal use.

In one embodiment, the invention is implemented by a server, a terminal, and a communication network connecting them. The server includes at least one processor, a main memory, a nonvolatile storage unit, and one or more hardware accelerators such as a graphics processing unit. The terminal includes a processor, a memory, a display device, and an input device. The server and the terminal communicate via a wired or wireless communication interface using a packet-based protocol.

The server executes a server program stored in the nonvolatile storage unit. The server program causes the processor to perform analysis, prompt generation, interaction with a generative AI model, media editing control, and result delivery. The terminal executes a client program that presents edited electronic content candidates and receives user selections and reactions.

The server stores electronic content files, analysis results, section information, and edited electronic content candidates in a data storage subsystem. The data storage subsystem includes a relational database management system or a key-value store and a file system or object storage. The server stores each electronic content as a file, such as a compressed audiovisual file, and associates a record in the database with each file, including identifiers, metadata, and processing status.

The server analyzes visual information and audio information constituting electronic content by using media processing software. The server uses a media codec library, such as a library conforming to a standard multimedia framework, to decode video frames and audio samples on the processor and the hardware accelerator. The server extracts visual frames at predetermined intervals, such as every fixed number of milliseconds, and stores frame-level metadata including timestamp, resolution, and frame index. The server also extracts an audio track as a sequence of samples with associated timestamps.

The server analyzes the visual frames using a visual recognition model. The visual recognition model is, for example, a convolutional neural network or a transformer-based neural network trained to output labels and bounding boxes for objects, scenes, and actions. The server preprocesses each frame by resizing the frame to a predetermined resolution, normalizing color channels, and converting the frame into a tensor representation. The server inputs the tensor representation into the visual recognition model running on the hardware accelerator. The server obtains as output a set of labels with confidence scores and, when applicable, spatial regions of interest. The server stores, for each frame, the labels, confidence scores, and associated timestamps in the database as part of the content features.

The server analyzes the audio track using a speech recognition model. The speech recognition model is, for example, a recurrent neural network, a transformer-based acoustic model, or a hybrid model, trained to convert audio waveforms into character or word sequences with timestamps. The server segments the audio track into overlapping windows, applies a Fourier transform or a filter bank to obtain a spectral representation, and feeds the spectral representation into the speech recognition model. The server obtains as output a sequence of tokens representing transcribed speech and associated time boundaries. The server stores the transcript with word-level or phrase-level timestamps in the database as content features. The server specifies sections that are potentially inappropriate based on the content features and time information. The server maintains a policy configuration including a list of content categories, threshold values, and mapping rules. The server compares the labels generated by the visual recognition model with the policy configuration and flags sections where a label related to a sensitive category, such as violence or offensive gesture, exceeds a predetermined confidence threshold. The server similarly compares the transcript with a lexicon of offensive expressions, applies pattern matching or regular expression matching, and flags sections where such expressions are present.

The server merges overlapping or adjacent time intervals corresponding to flagged frames and flagged transcript segments. The server applies a time-window aggregation algorithm that aligns visual and audio flags by projecting them onto a common timeline with a fixed time resolution. When two or more flags fall within a tolerance window, the server merges them into a single section. The server records, for each section, a start time, an end time, and at least one type of inappropriateness. The server stores this section information as a structured record in the database, linked to the original electronic content.

The server generates a prompt sentence for a generative AI model based on the section information and a content summary. The server generates the content summary by aggregating frequent labels, representative scenes, and key phrases from the transcript. The server uses a natural language generation module to compose a structured text description that includes the overall theme, the duration, and a list of sections that are potentially inappropriate, each with time boundaries and types.

The server constructs the prompt sentence in natural language in a predetermined format. The prompt sentence includes a role description, task instructions, constraints, and explicit editing requirements. For example, the server generates a prompt sentence such as:
“You are a video-editing assistant. The user wants a safe version of the following video for a family-friendly platform. The video duration is 300 seconds. The following time ranges contain inappropriate content:
   70-85 seconds: violent fight with visible blood.
   185-200 seconds: offensive language in the dialogue.
Generate three edited versions of this video:
1) Strict removal: completely cut out these segments and join remaining parts with smooth cross-fades.
2) Visual censoring: blur the violent visuals but keep audio intact.
3) Audio censoring: mute offensive words while keeping the video unchanged.
Return clear editing instructions with timestamps for each version.”

The server may generate other prompt sentences depending on policy or user preference. The server may generate, for example:
“Create two safe versions of this user-generated video. Remove or blur all scenes labeled as ‘blood’, ‘weapon’, or ‘physical assault’ between the following timestamps: [45.0-60.0, 130.0-145.0]. In version 1, remove these segments entirely with hard cuts. In version 2, blur the violent regions but preserve continuity of the story. Output precise editing instructions and indicate which version is stricter.”
or
“Given the transcript and timestamps where offensive words appear, generate a version of the video where the audio is muted only for the offensive words, but background sounds remain. Provide detailed instructions specifying which audio frames to mute and keep the overall rhythm of the dialogue natural.”

The server inputs the prompt sentence and the section information to the generative AI model. The generative AI model is implemented as a neural network stored in the server or in a remote computing environment. The generative AI model includes an encoder that converts tokenized text into embedding vectors and a decoder that generates output tokens representing editing plans. The generative AI model has been trained on a corpus of editing instructions and corresponding media transformations. During training, the server or another computing system used a loss function, such as cross-entropy loss for token prediction, and updated model weights using a gradient-based optimization algorithm. The training process used data augmentation techniques such as random time shifts, insertion of synthetic labels, and variation of editing instructions to improve robustness and generalization.

The server sends tokenized representations of the prompt sentence and structured representations of the section information to the generative AI model. The generative AI model outputs one or more editing plans. Each editing plan includes, for each section, an editing method, such as removal, visual masking, or audio muting, and optional parameters such as fade duration, blur radius, or volume attenuation factor. The generative AI model may output multiple alternative plans that differ in strictness, aggressiveness, or preservation of narrative continuity.

The server obtains information on the editing plans and converts the editing plans into a machine-executable representation. The server maps editing operations to commands of a media processing pipeline. The server uses a media processing tool, such as a command-line transcoder or a programmable media library, to implement cutting, concatenation, masking, and muting. The server translates a removal operation into a sequence of time-based trimming and concatenation operations. The server translates a visual masking operation into applying one or more filters, such as blur or pixelation, to a region of interest within specified time boundaries. The server translates an audio muting operation into applying a gain envelope or a filter to suppress audio signals within specified time boundaries. The server controls the program-controlled data processing apparatus to execute these commands. The server schedules media processing tasks, manages input and output buffers, and monitors resource usage on the processor and the hardware accelerator. The server stores each edited electronic content candidate as a new file and records its metadata in the database. The server generates reduced-size images and short-time playback segments as previews for each candidate by extracting representative frames and short clips from the edited files.

The terminal retrieves a list of edited electronic content candidates and associated previews sent by the server. The terminal displays an interactive display screen that includes summary information, reduced-size images, and short-time playback for each candidate. The user selects and plays back one or more candidates, compares how sections have been edited, and chooses a preferred candidate. The terminal sends the user's selection to the server. The server receives information indicating which candidate has been selected. The server determines that candidate as the final electronic content for posting. The server may perform a final transcoding step to conform to platform requirements such as codec, resolution, and bitrate. The server stores the final electronic content and marks its status as ready for distribution. The server then provides a posting interface or notifies an external system that the final electronic content is available.

The server presents, in natural language, the reason for specifying each potentially inappropriate section to the user. The server generates explanatory text that includes a description of the content features, such as detected labels and transcript phrases, and the corresponding policy rules that led to the section being flagged. The terminal displays this explanation. The user may react by confirming or disputing the classification. The terminal transmits user reactions, such as approval, rejection, or adjustment of strictness, to the server.

The server recognizes an emotional state of the user based on the reactions. The server may estimate satisfaction or dissatisfaction by observing patterns such as repeated rejections of strict versions, selection of milder versions, or explicit feedback. The server may also consider response times and frequency of switching between candidates. The server treats these signals as quantitative inputs and adjusts prompt generation parameters. For example, when the server detects that the user repeatedly selects candidates with less aggressive editing, the server adjusts the prompt sentence to request milder editing in subsequent content. Conversely, if the user frequently rejects candidates that preserve borderline content, the server modifies the prompt sentence to request more strict removal.

The server thereby adjusts generation conditions for the plurality of edited electronic content candidates based on the emotional state, such as changing the number of candidates, changing threshold levels for removal versus masking, or modifying instructions for preserving narrative continuity. By performing these adjustments at the level of structured prompt sentences and editing plans, the server directly influences how the generative AI model allocates editing methods across the timeline.

This configuration produces technical effects beyond mere automation of human editing. By aligning content features with precise time information in a structured section representation, the server minimizes redundant decoding and re-encoding operations and reduces computational overhead. By generating prompt sentences that incorporate both content features and time-based section information, the server ensures that the generative AI model produces editing plans that are temporally consistent with the original media stream, thereby reducing the need for manual correction and additional processing cycles. By controlling the program-controlled data processing apparatus in accordance with these editing plans, the server uses hardware resources efficiently and avoids unnecessary full-file recomputation. By presenting multiple candidates and adapting prompt generation based on recognized user emotional states, the server reduces the number of iterations required to reach an acceptable final version, which lowers communication load and server-side processing time. In another embodiment, the server executes variations of the visual recognition model and the speech recognition model. The server may use a transformer-based video model that jointly encodes temporal sequences of frames and an attention mechanism to correlate objects across time. The server may use a connectionist temporal classification-based acoustic model for robust alignment of speech and timestamps. The server may use different training regimes, such as curriculum learning or fine-tuning on domain-specific content, to further improve detection accuracy of content types that are likely to be inappropriate for a particular platform.

In another embodiment, the generative AI model includes multiple modules, such as a planning module and a filtering module. The planning module generates a high-level editing plan, and the filtering module refines editing operations based on resource constraints of the server or display capabilities of the terminal. The server may select different generative AI models depending on the type or length of electronic content, thereby balancing precision of editing with computational cost.

In another embodiment, the server maintains different policy configurations for different target audiences or platforms and dynamically incorporates these configurations into the prompt sentences. The server thereby uses a common analysis and editing infrastructure while adapting to varying policy requirements. The technical effect is that a single system can handle large volumes of heterogeneous electronic content while maintaining processing efficiency and high accuracy in the identification and treatment of potentially inappropriate sections.

In all of these embodiments, the server, the terminal, and the described neural network models cooperate to implement a specific data flow and a specific set of algorithmic transformations. The server performs structured extraction of content features, time-aligned section specification, generation of detailed prompt sentences, execution of model-driven editing plans on concrete media processing tools, and real-time, feedback-based refinement of future processing. This combination improves processing speed, reduces misalignment errors, optimizes use of computing resources, and enhances the overall technical performance of computer-implemented content moderation and editing.

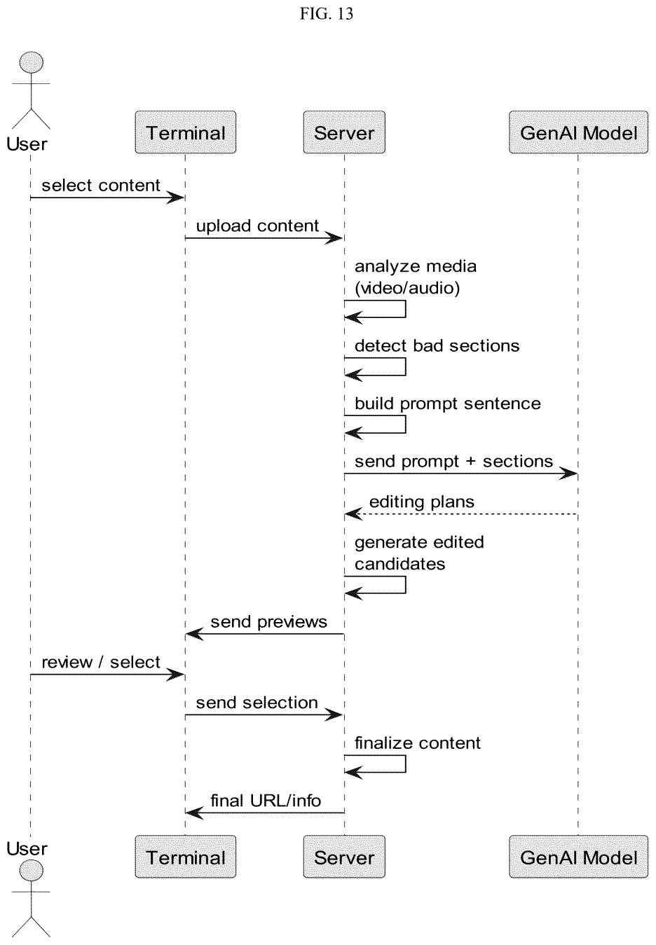

The following describes the processing flow using FIG. 13.

### Step 1

The user selects electronic content on the terminal.

The terminal receives, as input, a user operation indicating a media file stored in local storage. The terminal reads the file metadata (file path, size, format) and displays a confirmation screen. The terminal then sends, as output, an upload request including the media file data and metadata to the server via a network protocol.

### Step 2

The server receives and stores the electronic content.

The server receives, as input, the upload request containing binary media data and metadata from the terminal. The server parses the request, writes the binary data to a storage device as a media file, and registers a database record that includes a content identifier, file path, and status. The server outputs a content identifier to be used in subsequent processing.

### Step 3

The server decodes the media stream and extracts basic media information.

The server receives, as input, the stored media file path associated with the content identifier. The server uses a media codec library to decode container and stream headers and to read video and audio tracks. The server calculates, as data operations, duration, frame rate, resolution, and audio sampling rate. The server outputs structured metadata, including duration, frame count, and track configuration, and stores this metadata in the database.

### Step 4

The server extracts visual frames and audio segments with time indices.

The server receives, as input, the media file and its metadata. The server uses the media codec library to sample video frames at predetermined time intervals and to segment the audio track into fixed-length windows. The server assigns a timestamp to each frame and each audio window based on the media time base. The server outputs a sequence of frame objects and audio window objects, each containing a data buffer and a timestamp, and writes references to these objects into an internal data structure.

### Step 5

The server performs visual analysis on the extracted frames.

The server receives, as input, the sequence of frame objects with timestamps. The server preprocesses each frame by resizing, normalizing pixel values, and converting the frame into a tensor representation. The server feeds the tensors into a visual recognition model running on a hardware accelerator. The server performs neural network inference to compute label probabilities and, optionally, bounding boxes for objects and actions. The server outputs, for each frame, a set of labels, confidence scores, and timestamp-aligned results, and stores these as visual content features in the database.

### Step 6

The server performs speech recognition on the audio segments.

The server receives, as input, the sequence of audio window objects with timestamps. The server converts the audio samples into a spectral representation, such as a mel-spectrogram, and normalizes amplitude and frequency ranges. The server passes the spectral data through a speech recognition model that outputs tokens and time-aligned boundaries. The server concatenates tokens into words and phrases while maintaining their timing. The server outputs a transcript with word-level timestamps and stores the transcript as audio content features in the database.

### Step 7

The server identifies potentially inappropriate sections based on policy rules.

The server receives, as input, the visual content features and the transcript with timestamps. The server loads policy configuration data that defines content categories, threshold values, and lists of prohibited expressions. The server applies comparison operations between labels and policy thresholds to flag time intervals where certain sensitive labels exceed thresholds. The server applies string matching and pattern matching between transcript segments and a lexicon of offensive expressions to flag additional intervals. The server computes a union of flagged intervals by merging overlapping or close-by intervals into continuous sections. The server outputs a list of sections, each with a start time, end time, and type of inappropriateness, and records this section information in the database.

### Step 8

The server generates a content summary and prepares prompt elements.

The server receives, as input, the content features and the section information. The server aggregates frequent labels, characteristic scenes, and key transcript phrases to produce a high-level description of the content. The server uses statistical operations such as counting label frequencies and selecting top-ranking labels by confidence and coverage. The server also formats the section information as text fragments indicating time ranges and types. The server outputs a structured set of summary sentences and section description strings to be used in prompt generation.

### Step 9

The server composes a prompt sentence for the generative AI model.

The server receives, as input, the content summary and the section description strings. The server uses a natural-language generation routine to concatenate role description, task instructions, and explicit requirements into a coherent prompt sentence. The server performs string concatenation and template filling to insert duration, timestamps, and types of inappropriateness into a fixed prompt pattern. The server outputs a complete prompt sentence, for example:
“You are a video-editing assistant. The user wants a safe version of the following video for a family-friendly platform. The video duration is 300 seconds. The following time ranges contain inappropriate content:
   70-85 seconds: violent fight with visible blood.
   185-200 seconds: offensive language in the dialogue.
Generate three edited versions of this video:
1) Strict removal: completely cut out these segments and join remaining parts with smooth cross-fades.
2) Visual censoring: blur the violent visuals but keep audio intact.
3) Audio censoring: mute offensive words while keeping the video unchanged.
Return clear editing instructions with timestamps for each version.”

### Step 10

The server encodes prompt and section data for the generative AI model.

The server receives, as input, the prompt sentence and the structured section information. The server tokenizes the prompt sentence into a sequence of tokens and converts tokens into embedding vectors using a vocabulary and an embedding matrix. The server serializes the section information into a representation compatible with the generative AI model, such as a list of time-tagged annotations. The server outputs a combined model input structure that includes prompt token embeddings and section annotations, and sends this structure to the generative AI model.

### Step 11

The server obtains editing plans from the generative AI model.

The server receives, as input, the generative AI model output, which is a sequence of tokens or structured instructions. The server decodes tokens into natural-language text describing editing operations and parses the text to extract machine-readable operations. The server identifies, by text analysis and parsing rules, the editing method (removal, visual masking, audio muting), the associated time ranges, and any parameters such as fade duration or blur strength. The server outputs one or more editing plans, each plan being a list of editing operations with time ranges and parameters, and stores these plans for subsequent media processing.

### Step 12

The server maps editing plans to media processing commands.

The server receives, as input, the editing plans and the original media metadata. The server computes, for each operation, the corresponding command parameters for a media processing tool, such as cut points, filter application times, and region-of-interest coordinates. The server constructs command sequences or a filter graph that expresses the editing operations in terms of the media tool's command language. The server outputs a set of executable command specifications for each edited content candidate.

### Step 13

The server executes media processing to generate edited content candidates.

The server receives, as input, the command specifications and the original media file. The server invokes the media processing tool as a subprocess, passes the command parameters, and streams the media data through the configured filter graph. The server performs decoding, cutting, concatenation, masking, and muting operations according to the editing plans. The server writes the processed media to new output files, each corresponding to a different editing plan. The server outputs file paths and metadata for multiple edited electronic content candidates and records them in the database.

### Step 14

The server generates preview data for edited content candidates.

The server receives, as input, the edited media files. The server uses the media codec library to extract representative frames and short clips for each candidate. The server calculates preview timestamps, such as near the middle of the content or near edited sections, and decodes frames at those times. The server encodes reduced-size images and short-time playback clips at lower resolution and bitrate. The server outputs preview objects linked to each candidate, storing their locations in the database.

### Step 15

The terminal retrieves and displays edited content candidates.

The terminal receives, as input, a list of candidate identifiers and preview metadata from the server. The terminal requests and downloads reduced-size images and short clips for each candidate. The terminal draws an interactive display screen that arranges previews with summary information and editing descriptions. The terminal outputs a graphical interface that allows the user to select a candidate and to play preview clips.

### Step 16

The user reviews candidates and selects a preferred version.

The user receives, as input, visual and audio previews of the candidates on the terminal display. The user plays back selected previews and observes how sections have been edited. The user performs selection actions, such as tapping or clicking an on-screen control associated with a candidate. The terminal outputs a selection message containing the chosen candidate identifier and optional feedback signals to the server.

### Step 17

The server determines final electronic content and prepares it for posting.

The server receives, as input, the user's selection message containing a candidate identifier. The server verifies that the candidate belongs to the original content identifier and updates the database to mark the candidate as final. The server may perform additional transcoding or packaging operations on the selected edited content to comply with output format requirements. The server outputs a final media file and associated posting metadata ready for distribution.

### Step 18

The server generates and presents explanations of potentially inappropriate sections. The server receives, as input, the section information and the content features used to flag sections. The server generates explanatory text that includes the time range, the detected labels or transcript phrases, and the applicable policy rule that triggered the flag. The server outputs explanation strings and sends them to the terminal. The terminal displays the explanations to the user alongside the edited content candidates.

### Step 19

The user provides reactions and implicit feedback.

The user receives, as input, explanations and edited candidates. The user may explicitly indicate approval or disapproval of certain edits or choose stricter or milder candidates. The user may also implicitly provide feedback through behavior, such as repeatedly changing selections or spending more time on specific candidates. The terminal records these reactions as event logs and transmits them, as output, to the server.

### Step 20

The server infers user emotional state and adjusts future generation conditions.

The server receives, as input, the reaction logs and selection patterns from the terminal. The server computes statistics such as the number of rejections, time spent per candidate, and preference for strict or mild editing. The server applies a rule-based or model-based inference algorithm to classify the user's emotional state, such as satisfied, dissatisfied, or seeking milder edits. The server updates stored generation conditions, such as thresholds used in policy rules and parameters in prompt templates. The server outputs adjusted configuration values that will influence subsequent prompt sentences and the distribution of editing methods across future edited content candidates.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content moderation and editing support systems for digital media largely rely on rigid rule-based filters or isolated machine learning classifiers that operate independently on visual information or auditory information. Such systems generally detect inappropriate elements by applying static keyword lists or simple image classifiers to entire files, and present coarse decisions such as “allow” or “block” to a user. As a result, these systems suffer from several technical problems from the standpoint of computer technology. First, conventional systems are not optimized to handle time-series information in a fine-grained manner. Visual frames and audio segments are rarely aligned and processed as unified time-series units. This leads to inaccurate detection of inappropriate elements, fragmented or overlapping segments, and inefficient use of processing resources on a server, because the same regions may be repeatedly analyzed or misaligned across modalities. Second, conventional systems do not effectively integrate generative AI models into the detection and editing workflow at the system level. Even when a generative AI model is available, it is typically used in an ad hoc manner, for example, only to generate free-form text, without a structured prompt sentence that encodes time-series detection results and without feedback control on the generative AI model's output. This causes unstable outputs, inconsistent explanations, and unreliable editing policies that are difficult to consume programmatically, which degrades the reliability and performance of the overall computer system.

Third, existing systems rarely adapt content editing policies to a user's emotional state in a technically integrated fashion. Emotion recognition, if used at all, is often implemented as a separate analytics function that is not tied to specific edited candidate content or to the generation of prioritized editing operation sequences. As a consequence, server-side processing cannot dynamically prioritize or adjust deletion, masking, sound volume control, or replacement of acoustic information based on a real-time emotional profile of the user, which limits the system's ability to optimize both user experience and computational resource usage.

Fourth, user interfaces in conventional systems provide only static or batch-oriented interaction. Users generally see a single edited output or a simple “on/off” filter choice, without real-time or iterative feedback that is tightly coupled to server-side analysis. This lack of an interactive loop between a server and a user terminal prevents efficient refinement of editing plans and forces repeated re-uploads or re-processing, thereby increasing network traffic, server load, and latency.

Accordingly, there is a need in the field of computer technology for an improved system that: (i) analyzes posting-target information content as time-series information across visual information and auditory information; (ii) constructs structured prompt sentences embedding detection results and time-aligned features for a generative AI model; (iii) generates explanation information and editing operation sequences at the server based on responses from the generative AI model; (iv) estimates and uses a user's emotional state as a parameter in prioritizing and adjusting edited candidate content; and (v) cooperates with a user terminal in an interactive manner so that selection information from the user is efficiently reflected in final editing processes. Such a system should improve the technical performance, determinism, and scalability of server-side content moderation and editing operations by transforming how computational resources are orchestrated for detection, explanation, and editing of digital content.

The specific processing by the specific processing unit 290 of the data processing device 12 in Application Example 2 is realized by the following means.

The present invention provides a server comprising a processor configured to analyze a content of posting-target information content and extract candidate inappropriate elements as time-series information; to construct a prompt sentence for instructing a generative information processing model to determine validity of the candidate inappropriate elements and to generate an editing policy, based on an analysis result including visual information and auditory information corresponding to the candidate inappropriate elements; to generate explanation information for presenting, in a natural language, reasons for the candidate inappropriate elements to a user, based on a determination result and the editing policy regarding the candidate inappropriate elements obtained from the generative information processing model; to determine, for each of a plurality of editing plans based on the explanation information and the editing policy, an editing operation sequence for generating edited candidate content of the information content; to estimate an emotional state of the user based on expression information and voice information of the user at a time of acquisition or viewing of the information content; to adjust, with prioritization, editing details of at least a part of the edited candidate content, including at least one of deletion, masking, sound volume control, and replacement of acoustic information, based on the emotional state and the editing operation sequence; to transmit the adjusted edited candidate content to a user terminal in association with identification information and the explanation information; and to receive selection information of the edited candidate content from the user terminal and execute a final editing process on the information content based on the selection information. This enables the server to perform fine-grained, time-series-aware moderation and editing of information content, to control a generative AI model through structured prompt sentences, to generate machine-consumable and user-understandable explanations and editing plans, and to dynamically adjust and prioritize editing operations according to a user's emotional state in cooperation with an interactive user terminal, thereby improving the technical performance, reliability, and efficiency of the overall computer-based content processing system.

The term “posting-target information content” refers to digital information, such as media data or document data, that is intended to be transmitted, stored, or published via an information processing system, including but not limited to moving image data, still image data, sound data, text data, and combinations thereof.

The term “candidate inappropriate elements” refers to portions, segments, or features of posting-target information content that are tentatively identified, by automated analysis, as potentially including content that may be undesirable, harmful, or non-compliant with a predetermined policy, prior to final determination by a generative information processing model or other evaluation.

The term “time-series information” refers to information that is associated with temporal indices or timestamps, including sequences of visual frames, audio samples, or other data units that are ordered in time and are processed on a per-interval or per-frame basis.

The term “analysis result” refers to data produced by processing posting-target information content, the data including extracted features, classification outputs, detection scores, timestamps, or other derived information relating to visual information, auditory information, or both.

The term “visual information” refers to information obtained from image data or video data, including but not limited to pixel values, frame data, detected objects, detected text, spatial features, and any other information derived from two-dimensional or three-dimensional visual signals.

The term “auditory information” refers to information obtained from sound data or audio data, including but not limited to waveform samples, spectral features, recognized speech text, detected sound events, and any other information derived from acoustic signals.

The term “generative information processing model” refers to an information processing model, such as a machine-learned model or statistical model, that is configured to generate output data including at least one of natural language text, structured data, or transformed representations, in response to input data including a prompt sentence or other conditioning information.

The term “prompt sentence” refers to an input sequence, typically expressed in a natural language or structured text format, that is supplied to a generative information processing model to specify a task, provide context, convey constraints, or otherwise guide generation of output data by the model.

The term “editing policy” refers to information indicating rules, recommendations, or strategies for modifying posting-target information content, the information including suggested operations such as cutting segments, applying masking, adjusting audio, or other transformations to address candidate inappropriate elements.

The term “explanation information” refers to data, typically in natural language form, that describes reasons, grounds, or context for an identification of candidate inappropriate elements, including references to time positions, categories, and policy considerations, and that is suitable for presentation to a user.

The term “edited candidate content” refers to information content that would result if one or more editing operations, as specified by an editing operation sequence or editing policy, were applied to posting-target information content, the edited candidate content existing at least logically as a potential edited version prior to or after actual rendering.

The term “editing operation sequence” refers to an ordered set of editing operations, each operation specifying at least a time range and a type of modification, that collectively define how posting-target information content is to be transformed into edited candidate content. The term “expression information” refers to information relating to a user's physical or behavioral expressions, including but not limited to facial expressions, gesture patterns, or posture features, acquired from sensor data such as image data or motion data.

The term “voice information” refers to information relating to a user's vocal output, including but not limited to raw audio signals, prosodic features, pitch contours, and recognized speech text, obtained from microphones or other audio capture devices.

The term “emotional state” refers to an estimated psychological condition of a user, such as anger, joy, sadness, fear, or neutrality, represented as at least one label, score, or probability distribution, derived from analysis of expression information, voice information, or a combination thereof.

The term “deletion” refers to an editing operation that removes at least a part of posting-target information content from an edited version, such that the removed part is not presented in the edited candidate content.

The term “masking” refers to an editing operation that reduces visibility or intelligibility of at least a portion of posting-target information content, for example by applying blurring, pixelation, overlaying graphics, or otherwise obscuring visual or auditory details. The term “sound volume control” refers to an editing operation that changes an amplitude level or relative loudness of auditory information within a specified time range, including muting, attenuation, or amplification of an audio signal.

The term “replacement of acoustic information” refers to an editing operation that substitutes at least a portion of existing auditory information in posting-target information content with alternative auditory information, such as background music, sound effects, or silence. The term “identification information” refers to data that uniquely or distinctively associates edited candidate content with corresponding records or segments, including but not limited to identifiers, indices, metadata entries, or references used by a server or a user terminal. The term “user terminal” refers to an information processing apparatus operated by a user, such as a mobile device, a personal computer, or a dedicated client device, that is configured to transmit posting-target information content to a server, receive edited candidate content and explanation information, and accept selection operations from the user.

The term “selection information” refers to data indicating at least one choice made by a user among a plurality of edited candidate contents or editing options, such data including identifiers of selected candidates, user preferences, or confirmation signals used to control a final editing process.

The term “final editing process” refers to a processing operation performed by a server or another processor, in which posting-target information content is transformed into a final edited version in accordance with selection information and at least one editing operation sequence.

In an embodiment, a server cooperates with one or more user terminals to implement the claimed system. The server includes at least one processor, a memory storing programs and models, a network interface, and optionally a hardware accelerator such as a graphics processing unit. The terminal includes at least one processor, a memory, an image sensor, a microphone, a display device, and a network interface.

The server executes an operating system and one or more middleware components such as a web server, an application server, and a media processing engine. The server stores, in the memory, executable modules including at least: a content ingestion module, a time-series analysis module, a feature extraction module, a visual analysis module, an audio analysis module, a fusion module, a prompt construction module, a generative AI client module, an explanation generation module, an editing policy module, an emotion estimation module, an editing operation sequence module, an editing engine, and a terminal interaction module. The terminal stores, in its memory, executable modules including at least: a capture module, a content upload module, a user interface module, a preview module, and a selection transmission module.

The server uses a media processing library such as a generic multimedia framework (for example, a framework equivalent to a well-known command-line tool for audio and video processing) to demultiplex incoming media containers, decode video into frames, and decode audio into sample buffers. The server uses a computer vision library such as a generic open-source image processing library to perform low-level image processing, including resizing, color space conversion, and basic filtering. The server uses a machine learning framework such as a generic tensor computation framework to execute neural network models for classification, detection, and emotion estimation. The server optionally uses a cloud speech recognition service to convert audio into text.

The server represents posting-target information content as a data structure including at least a content identifier, metadata, a sequence of video frames with timestamps, and a sequence of audio segments with timestamps. Each video frame is stored as a multi-dimensional tensor (for example, height×width× channels) in memory. Each audio segment is stored as either raw waveform samples or frequency-domain features (for example, mel-spectrograms). The server further maintains a detection result data structure, including a list of candidate inappropriate elements, each entry having fields such as start time, end time, modality (visual or auditory), category label, confidence score, and feature references.

The server performs visual analysis by applying a trained neural network to frame tensors. In one example, the server uses a convolutional neural network with multiple convolution layers, batch normalization layers, pooling layers, and fully connected layers. The network receives a normalized frame tensor and outputs, for each frame, class probabilities over a predetermined set of content categories such as violence, explicit imagery, hate symbol, or safe content. In another example, the server uses an object detection network (for example, a region-based detection architecture or a single-shot detection architecture) that outputs bounding boxes, category labels, and confidence scores for each detected region. These outputs are stored as part of the detection result data structure.

The server performs auditory analysis by computing features such as mel-frequency cepstral coefficients or log-mel spectrograms for each audio segment and by applying a recurrent neural network or transformer-based network. In one example, a bidirectional recurrent network receives a sequence of feature vectors and outputs classification scores for each time step, indicating presence of profanity, hate speech, or other categories. In another example, the server uses an external speech recognition service to obtain time-aligned transcripts and then applies a text classifier implemented in a neural network framework, using word embeddings or subword embeddings, attention layers, and fully connected layers to output content categories for text spans. The server records each detected phrase or time range as another type of candidate inappropriate element.

The server aligns visual and auditory detections by using their timestamps. For each candidate inappropriate element from the visual analysis, the server searches for overlapping elements in the audio domain and merges them into unified segments when overlap exceeds a threshold. The server computes a combined risk score using a non-linear function, such as a weighted sum followed by a logistic transformation, in order to normalize scores across modalities. This fusion process is implemented as a deterministic algorithm that reduces inconsistent or fragmented segments and thereby improves precision and recall compared to naive independent processing.

The server constructs a prompt sentence for a generative AI model by transforming structured detection results into natural language descriptions. The server uses the prompt construction module to read the detection result data structure and to generate a text sequence that includes: summaries of the content, a list of segments with timestamps and labels, and explicit instructions. For example, the server may construct a prompt sentence such as:
“You are a content moderation assistant. The following video has segments with potential issues. Segment 1:00:10-00:15, label: violent_act, description: a person hitting another person. Segment 2:00:20-00:23, label: strong_profanity, transcript: ‘[text]’. For each segment, decide whether it is inappropriate for a general audience, explain briefly why it may be inappropriate, and suggest specific edit operations (cut, blur, mute, or replace audio). Return the results in a structured, itemized form.”

The server supplies the prompt sentence and optional additional context to a generative AI model via the generative AI client module. The generative AI model is stored either on the same server or on a separate computing system and is configured as a neural network with an encoder-decoder or autoregressive architecture. In one example, the generative AI model is a transformer network having multiple self-attention layers, feed-forward layers, and positional embeddings. The model is trained on large-scale text corpora using a next-token prediction objective, with a loss function such as cross-entropy, and parameters are updated using an optimization algorithm such as stochastic gradient descent or an adaptive variant.

The server configures the generative AI model with hyperparameters such as maximum sequence length, tokenization scheme, temperature, and top-k or nucleus sampling thresholds. The server limits model output length and enforces structural constraints by embedding explicit instructions in the prompt sentence (for example, requiring items to be separated by markers). By doing so, the server ensures that the generative output can be reliably parsed into an internal representation, which improves system reliability and reduces failure modes associated with unstructured outputs.

The server uses an emotion estimation module to determine an emotional state of the user. The server receives expression information from the terminal in the form of facial images or skeletal keypoints. The server processes the images using a convolutional network specialized for facial expression recognition, which outputs logits over categories such as anger, joy, sadness, fear, and neutral. The server applies a softmax function to convert logits into probability values, and the probabilities constitute an emotion profile. The server may additionally process voice information from user speech segments, extracting prosodic features such as pitch, energy, and speaking rate, and applying a separate neural network to produce another estimate of emotional state. The server then fuses the facial and vocal estimates using a weighted average or a learned gating mechanism to obtain a final emotional state representation.

The server uses the emotional state as an input to the editing policy module. For example, if the emotional state indicates a high anger score, the editing policy module may increase the priority for editing operations that soften aggressive parts (for example, choosing deletion rather than masking in certain segments). If the emotional state indicates a calm or neutral state, the editing policy module may favor preserving more of the original content and selecting less intrusive operations. This use of emotional state is not merely a human convenience but changes how computational resources are allocated and how segments are prioritized, thereby reducing repeated re-analysis and improving overall throughput.

The server generates editing operation sequences by combining outputs of the generative AI model and internal policy rules. The generative AI model outputs recommended operations for each segment, and the server verifies these recommendations against safety constraints and available resources. The editing operation sequence module encodes each operation with fields such as operation type (cut, blur, mute, replace audio), target segment identifier, spatial region (for visual operations), and parameter values (for example, blur kernel size, decibel reduction level). The server stores the sequence as a structured list that can be processed directly by the editing engine.

The server executes the editing engine to apply the editing operation sequence to the original media content. The editing engine invokes media processing functions that operate on frame buffers and audio buffers. For example, when applying masking, the server performs convolution operations on selected regions of each frame using a blur kernel, or replaces pixel values with averaged values, which is implemented as a matrix operation over the frame tensor. When applying deletion, the server updates an index mapping between original timestamps and output timestamps, skipping segments associated with cut operations. When applying sound volume control, the server multiplies sample amplitudes by a gain factor in specified ranges. By encoding editing operations as a sequence of low-level media transformations, the system improves computational efficiency and reduces redundant decoding and encoding steps.

The server transmits edited candidate content to the terminal. In one embodiment, the server generates low-resolution preview versions to reduce communication load. The server uses temporal downsampling and spatial downsampling to produce preview content, thus reducing data size while preserving structural correspondence with the original timeline. The server associates each preview with identification information and explanation information, and sends these data to the terminal. The terminal displays the previews and explanations to the user and permits the user to select one of the edited candidate contents or to adjust per-segment operations.

The terminal displays explanation information and time-series position information in a synchronized manner. The terminal uses a timeline bar where segments corresponding to candidate inappropriate elements are colored or marked. The terminal overlays text explanations when the user scrubs over a marked region or taps an indicator. By rendering the explanations at precise positions, the terminal helps the user quickly understand the technical effect of each editing plan. The terminal transmits selection information, including selections of particular edited candidate contents, back to the server.

The server receives the selection information and executes a final editing process at higher resolution or final encoding parameters. Because the server has already computed the editing operation sequences and has stored intermediate data such as decoded frames and segment indices, the final editing process is efficient and avoids redundant feature extraction or model inference. This improves processing speed and reduces load on network and computational resources.

In one example, a user records a short video containing background graffiti. The terminal uploads the video to the server. The server detects the graffiti region using a convolutional network trained on urban scenes and identifies text content within the region using an optical character recognition model. The server recognizes certain words that match a prohibited list. The server constructs a prompt sentence:
“Analyze the following video segments for inappropriate visual text. Segment 1:00:05-00:07, bounding box with text ‘[redacted]’. Determine if this segment is inappropriate for a general audience, explain the reason briefly, and suggest how to edit (cut, blur, or leave as is).”

The generative AI model responds that the segment is likely inappropriate due to offensive language and recommends blurring the specific region while keeping the rest of the video intact. The server encodes this recommendation as a masking operation in the editing operation sequence, generates edited candidate content with the region blurred, and sends a preview and explanation to the terminal. The user selects the blurred version, and the server produces a final high-resolution video with the graffiti masked. The technical benefit is that the server avoids cutting entire time spans unnecessarily, thereby preserving content while still complying with policy, and it achieves this in a computationally efficient manner via localized filtering operations.

In another example, a user uploads a video where heated language appears in the audio track. The server uses a speech recognition service to convert audio to text and an audio classifier to detect profanity. The server constructs a prompt sentence:
“This video transcript includes the following phrase at 00:12-00:15: ‘[text]’. Determine whether this phrase is inappropriate for a general social platform, explain why, and propose one or more edits such as muting the phrase, replacing it with a beep sound, or leaving it unchanged.”

The generative AI model recommends muting the phrase and adding a beep sound. The server converts this into a sound volume control and replacement operation, applies the operations to the audio stream, and produces edited candidate content. The server also uses the emotion estimation module to determine that the user appears angry during this segment, and therefore assigns higher priority to edits that reduce perceived aggression. This coupling of emotion analysis and editing policy improves the alignment between user state and system behavior and reduces the risk of misaligned edits.

The server trains the neural networks used in the system using supervised learning. For content classification, the server uses a training dataset of labeled frames and audio segments. The server computes a loss function such as cross-entropy between predicted class probabilities and ground truth labels, and updates network weights via backpropagation and an optimizer such as an adaptive optimizer. The server performs data augmentation during training, including random cropping, flipping, color jitter for images, and noise addition, pitch shifting, or time stretching for audio, to make the models robust to variations. For emotion estimation, the server uses labeled facial expression datasets and speech emotion datasets with similar training procedures. These training operations result in models that generalize to real-world content and reduce false positives and false negatives, thereby improving both precision and recall.

The server uses specific data structures and algorithms for managing time-series information. For example, the server may store segment boundaries in an interval tree, which allows efficient querying of overlapping segments during fusion and editing. The server may use a priority queue keyed by risk score and emotional weighting to select which segments to process first when computational resources are limited. These data structures reduce computational complexity and improve scalability, especially when handling long or numerous content items concurrently.

The server improves computer technology in several ways. First, by integrating time-aligned visual and auditory analysis with structured prompt construction, the system reduces redundant model invocations and post-processing, leading to lower latency and higher throughput. Second, by representing editing operations as structured sequences and by performing localized media transformations, the system reduces the amount of decoding and encoding required, thereby improving computational efficiency and reducing energy consumption. Third, by using emotion-aware prioritization, the system reduces the number of iterations in which users re-edit or re-upload content, which translates into decreased network traffic and server load. Fourth, by constraining generative AI output via structured prompt sentences and internal validation logic, the system mitigates non-deterministic behavior of generative models and provides stable, machine-consumable outputs that can be integrated into an automated pipeline, thus improving reliability.

Alternative embodiments are possible. The server may use different neural network architectures, such as three-dimensional convolutional networks for spatio-temporal analysis of video, or hierarchical transformers that operate on sequences of segment-level embeddings. The server may use alternative loss functions such as focal loss for imbalanced data or margin-based losses for emotion classification. The server may deploy separate generative AI models for explanations and for editing plans, where one model is specialized in user-facing natural language and another is specialized in structured planning. The server may also execute parts of the analysis, such as lightweight models for preliminary detection, on the terminal to further reduce server load and communication bandwidth.

The terminal may be implemented as a smartphone, a tablet, a personal computer, or another network-enabled device. The terminal may perform local pre-processing such as downsampling or pre-segmentation to optimize network usage. The terminal may also cache explanation information and preview clips to allow offline review. In each case, the cooperation between the server and the terminal is designed such that heavy neural computation is mainly performed by the server, while the terminal focuses on acquisition, display, and interaction.

Through these embodiments, the system uses a generative AI model and carefully constructed prompt sentences not merely to automate human tasks but to change how a computer system represents, processes, and edits multimedia content. The structure of the data, the sequence of technical operations, and the integration of neural network inference with classical algorithms collectively produce tangible improvements in processing accuracy, speed, scalability, and robustness, thereby providing a concrete technological solution rather than an abstract idea.

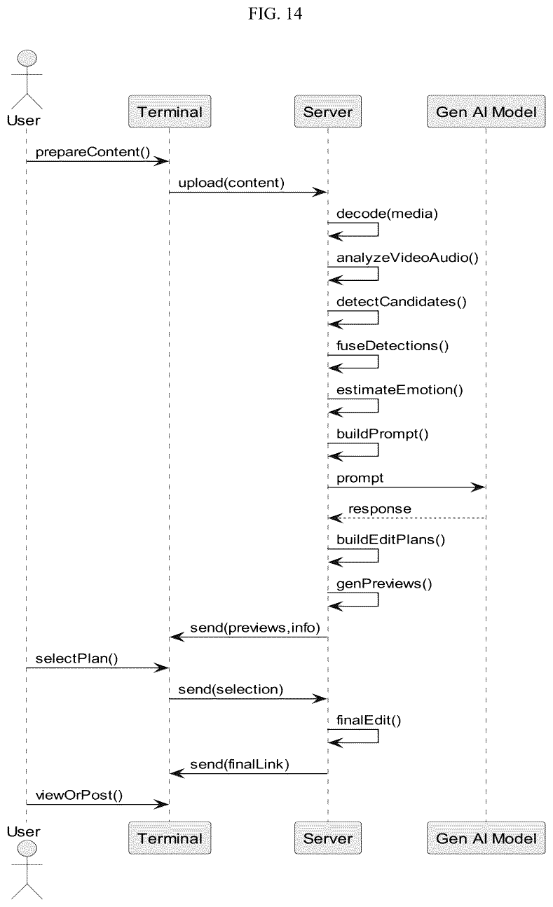

The following describes the processing flow using FIG. 14.

### Step 1

User operates the terminal to prepare posting-target information content.

User selects either to capture new media or to choose an existing media file stored on the terminal. The input to this step is the user's operation (for example, “record” or “select file”). The output is a selection result indicating a source of posting-target information content.

### Step 2

Terminal acquires visual information and auditory information as time-series data. Terminal activates an image sensor and a microphone to capture moving image data and sound data, or reads stored media data from local storage. The input is the selection result from Step 1. Terminal decodes or directly obtains video frames and audio samples, assigns timestamps to each frame and audio segment, and compresses them using a media encoder. The output is a compressed media stream or file including time-aligned visual information and auditory information.

### Step 3

Terminal transmits the posting-target information content to the server.

Terminal uses a network interface to establish a connection with the server and sends the compressed media stream or file together with metadata such as content identifier, duration, and format. The input is the compressed media data from Step 2. Terminal may divide the media into chunks and attach sequence numbers and timestamps. The output is a series of network packets carrying the posting-target information content and associated metadata to the server.

### Step 4

Server receives and stores the posting-target information content.

Server accepts the incoming network packets, reassembles them into a media file or stream, and writes the data into a storage device. The input is the media data and metadata from Step 3. Server verifies integrity (for example, using checksums), identifies the container format, and registers a content identifier in a management table. The output is a stored media object and a registration record associating the content identifier with storage location and basic attributes.

### Step 5

Server decodes the media into time-series visual and auditory data.

Server invokes a media processing library to demultiplex the container and to decode the video track into a sequence of frame tensors, and to decode the audio track into a sequence of audio sample buffers. The input is the stored media object from Step 4. Server converts each frame into a normalized format (for example, resized resolution, fixed color space) and segments the audio into fixed-length windows with timestamps. The output is a time-series data structure containing an ordered list of frame tensors and an ordered list of audio segments, each with associated timestamps.

### Step 6

Server extracts visual features for each frame.

Server applies image pre-processing (such as normalization and noise reduction) to each frame tensor and then inputs the processed frame into a visual neural network. The input is the frame sequence from Step 5. Server computes intermediate feature maps in convolutional layers and aggregates them into feature vectors representing objects, scenes, and textures. The output is a sequence of visual feature vectors, each linked to a frame timestamp.

### Step 7

Server detects visual candidate inappropriate elements.

Server inputs the visual feature vectors into a classification or detection head of the neural network. The input is the visual feature sequence from Step 6. Server computes class probabilities and bounding boxes for each frame, compares confidence scores with predetermined thresholds, and selects frames and regions that exceed the thresholds. The output is a list of visual candidate inappropriate elements, each element including at least a timestamp range, a bounding box (when applicable), a category label, and a confidence score.

### Step 8

Server extracts auditory features for each audio segment.

Server transforms each audio segment into time-frequency representations, such as spectrograms or mel-spectrograms, and may compute additional statistical features. The input is the audio segment sequence from Step 5. Server performs a discrete Fourier transform or filter-bank processing and then normalizes the resulting feature matrices. The output is a sequence of auditory feature vectors or matrices, each associated with a time interval.

### Step 9

Server detects auditory candidate inappropriate elements.

Server inputs the auditory feature sequence into an audio analysis network or uses speech recognition followed by a text classifier. The input is the auditory feature sequence from Step 8 and, in the speech recognition case, recognized text fragments with timestamps. Server calculates classification scores for categories such as profanity or hate speech, and flags segments where the scores exceed thresholds. The output is a list of auditory candidate inappropriate elements, each including a start time, end time, category label, textual content (when available), and a confidence score.

### Step 10

Server fuses visual and auditory detections into unified candidate inappropriate elements. Server aligns the timestamps of visual and auditory candidate inappropriate elements and applies an interval-merging algorithm. The input is the two lists from Steps 7 and 9. Server merges overlapping intervals, resolves conflicts by using risk score calculations, and generates combined elements where both modalities contribute. The output is a unified candidate list, where each candidate inappropriate element includes a time-series interval, modality indicators, combined risk score, and references to underlying features.

### Step 11

Server constructs structured detection records.

Server converts each unified candidate inappropriate element into a structured record stored in a data structure, such as a table or object list. The input is the unified candidate list from Step 10. Server assigns identifiers to each candidate, stores start and end timestamps, category labels, confidence values, and summary descriptions generated from detection metadata. The output is a detection record set that can be referenced by later modules.

### Step 12

Server estimates the user's emotional state.

Server receives expression information (for example, images of the user's face) and voice information from the terminal or extracts them from the posting-target information content when applicable. The input is the user-related media data and, optionally, user identification metadata. Server applies an emotion recognition network to the expression information and voice information, computes logits for emotion categories, and converts them into probabilities. The output is an emotional state profile indicating, for each category, a probability or intensity score, and a dominant emotional state for the user.

### Step 13

Server constructs a prompt sentence for the generative AI model.

Server reads the detection record set and the emotional state profile and generates an instruction text. The input is the detection records from Step 11 and the emotional state from Step 12. Server assembles a natural language description that lists candidate inappropriate elements with timestamps, labels, and brief descriptions, and includes explicit instructions regarding required judgments and edit suggestions. Server also encodes constraints on output format. The output is a prompt sentence containing structured content suitable for input to a generative AI model.

### Step 14

Server invokes the generative AI model and obtains refined decisions and suggested edits. Server sends the prompt sentence to a generative AI model via an appropriate interface. The input is the prompt sentence from Step 13 and, optionally, supplemental context such as policy summaries. The generative AI model processes the prompt using an internal neural network, generating text that includes determinations about which candidate inappropriate elements are actually inappropriate, explanations for those determinations, and proposed editing operations for each element. Server receives this generated text. The output is a generative response containing refined decisions, explanation sentences, and edit recommendations.

### Step 15

Server parses the generative AI model response into internal structures.

Server analyzes the text output from the generative AI model according to markers and structure specified in the prompt. The input is the generative response from Step 14. Server identifies segment identifiers, time ranges, categories, explanation texts, and proposed edit types, and maps them back to detection record identifiers. The output is an augmented detection record set, where each record contains validated flags, natural language explanations, and candidate editing operations.

### Step 16

Server generates editing operation sequences based on model suggestions and internal rules.

Server uses the augmented detection records and editing policies to construct an ordered list of editing operations. The input is the augmented detection record set from Step 15 and system-level policy parameters. Server selects, for each segment, specific operations such as deletion, masking, sound volume control, or replacement of acoustic information, and orders them by time and dependency. Server encodes operation parameters including time intervals, spatial regions for visual changes, and gain factors for audio changes. The output is at least one editing operation sequence representing a complete editing plan.

### Step 17

Server produces multiple edited candidate content versions.

Server applies each editing operation sequence to the original media content, at least in preview form. The input is the editing operation sequences from Step 16 and the decoded media data from Step 5. Server invokes a media processing library to perform localized transformations on frames and audio segments according to the sequence, and then encodes the modified media into preview files with reduced resolution and bitrate. The output is a set of edited candidate contents, each associated with an operation sequence identifier and an explanation summary.

### Step 18

Server associates edited candidate contents with explanation information and identification information.

Server links each edited candidate content to its corresponding detection records and explanation texts. The input is the edited candidate content set from Step 17 and the explanation texts contained in the augmented detection record set. Server generates identification information, such as candidate IDs and human-readable labels, and packages the media references and explanations together. The output is a structured response package containing edited candidate content identifiers, preview locations, and explanation information.

### Step 19

Server transmits the edited candidate contents and explanations to the terminal.

Server sends the structured response package to the terminal over the network interface. The input is the response package from Step 18. Server may choose a data format suitable for efficient transmission and may apply compression to previews. The output is a set of network messages containing edited candidate content previews and associated explanation information delivered to the terminal.

### Step 20

Terminal presents the edited candidate contents and explanations to the user.

Terminal receives the network messages and updates its user interface to display candidate previews and textual explanations. The input is the response data from Step 19. Terminal renders thumbnails, playback controls, and explanation overlays corresponding to time-series positions in the original content. The output is a user interface state in which the user can visually and audibly inspect each edited candidate content and read the reasons for each recommended edit.

### Step 21

User selects a desired edited candidate content or adjusts per-segment edits.

User reviews the previews and associated explanation information displayed on the terminal. The input is the visual and auditory presentation provided by the terminal in Step 20. User performs selection operations, such as choosing one of the candidate contents or changing specific operations for certain segments. The output is the user's selection decisions, represented as choices of candidate identifiers and optional overrides of per-segment editing operations.

### Step 22

Terminal transmits selection information to the server.

Terminal converts the user's selection decisions into structured selection information. The input is the selection decisions from Step 21. Terminal includes identifiers of chosen edited candidate contents, details of any overridden operations, and target export parameters, and transmits this information to the server. The output is a set of network messages containing selection information sent to the server.

### Step 23

Server performs a final editing process based on the selection information.

Server interprets the received selection information and chooses the appropriate editing operation sequence or modifies it according to user overrides. The input is the selection information from Step 22 and the original high-quality media data. Server executes a final editing pipeline using full-resolution frames and high-fidelity audio, reapplying the requested operations at production quality. The output is a final edited version of the information content, stored in a designated output location and associated with a final content identifier.

### Step 24

Server provides access information for the final edited content to the terminal.

Server generates a reference such as a uniform resource identifier or a content ID and returns it to the terminal along with basic metadata. The input is the final edited content from Step 23. Server registers the final content in a catalog or publishing system. The output is an access response containing a link or identifier that the terminal can use to present or post the finalized content.

### Step 25

Terminal enables the user to view or post the final edited content.

Terminal receives the access information and displays an option for the user to preview the final edited content and to distribute it through a chosen service. The input is the access response from Step 24. Terminal may fetch and play the final content for confirmation and may initiate an upload or publishing operation to an external platform. The output is the presentation of the final edited content to the user and, if requested, the completion of posting to the designated destination.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

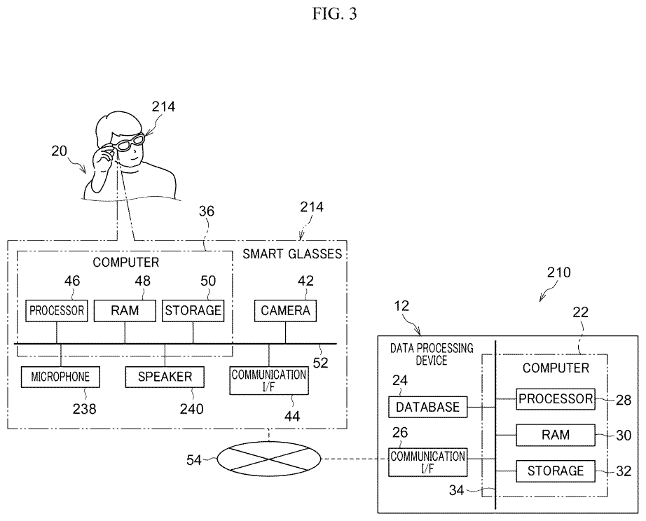

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

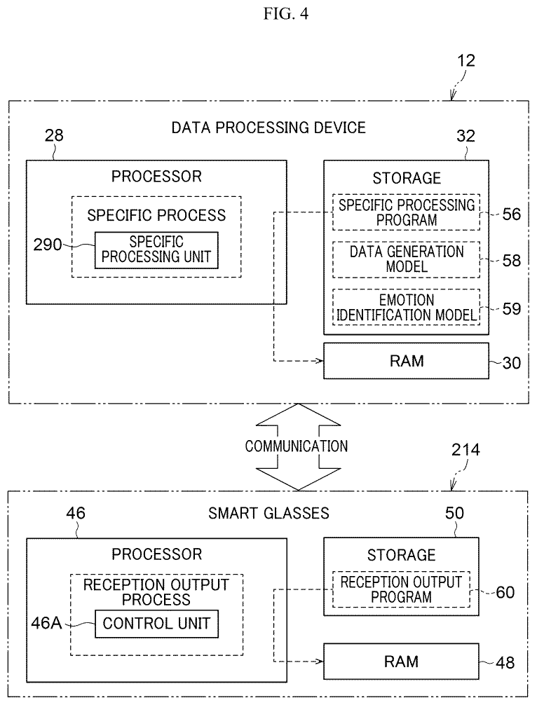

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above. Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

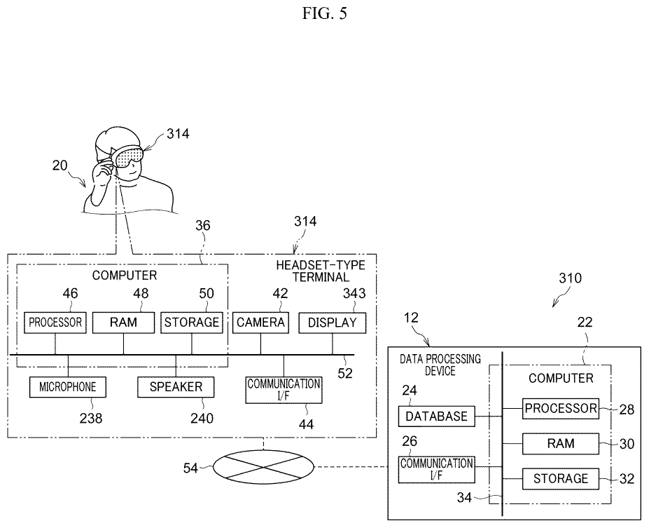

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

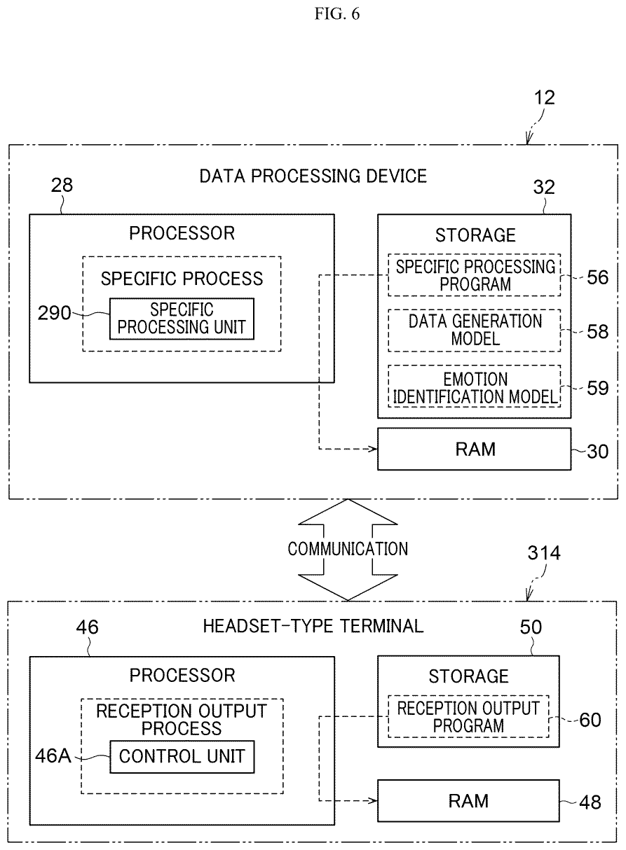

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

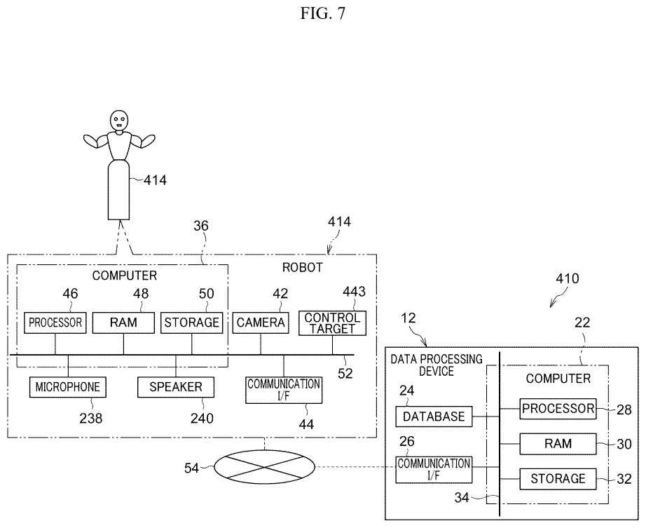

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

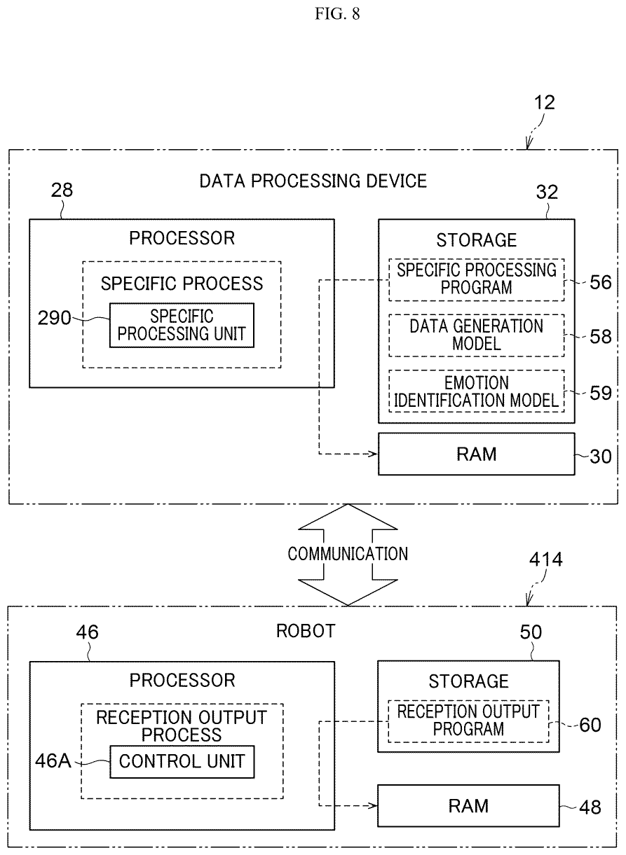

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

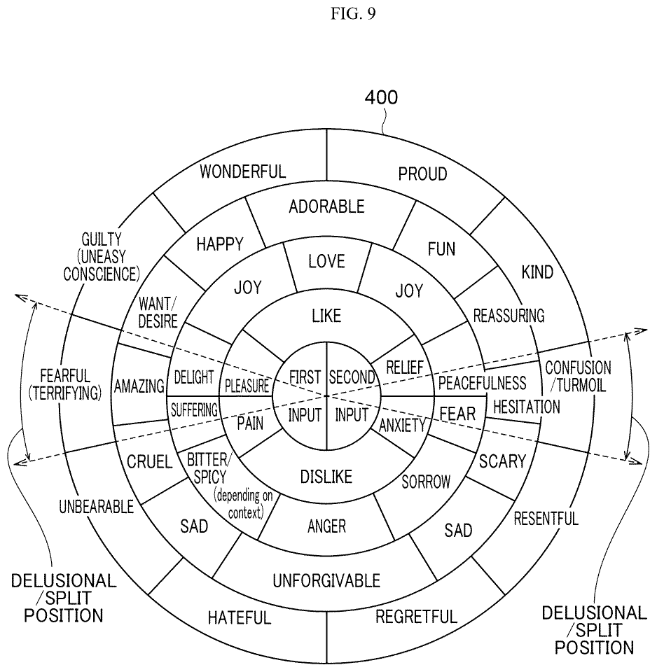

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

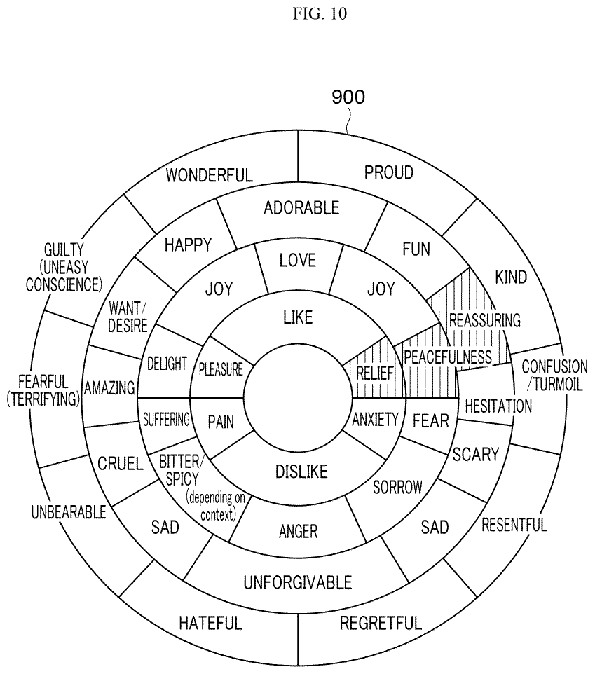

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
analyze content of information including time-series media information scheduled to be posted, and generate integrated time-series information by integrating visual information and audio information obtained from the time-series media information on the basis of time information,
extract, on the basis of the integrated time-series information, time intervals including elements that are potentially inappropriate, and generate element information including, for each time interval, a type of the potentially inappropriate element and evidence information related to the element,
generate a prompt sentence, on the basis of the element information and the integrated time-series information, for instructing a generative information processing model to identify the potentially inappropriate elements and to generate editing proposals, and input the prompt sentence into the generative information processing model to obtain response information including editing proposals for each time interval,
generate explanation information that explains, in natural language, reasons why the potentially inappropriate elements are determined to be inappropriate, on the basis of the element information and the response information, and cause a user terminal to present the explanation information,
determine an editing operation sequence, on the basis of the response information and editing operation information received from a user, the editing operation sequence applying, to the time-series media information for each time interval, at least one editing process selected from a deletion process, a masking process, an audio disabling process, and another editing process, and generate a plurality of edited time-series media information candidates in accordance with the editing operation sequence, and
cause the user terminal to present the edited time-series media information candidates, and determine final edited time-series media information on the basis of selection information received from the user.

### Supplementary 2

The system according to supplementary 1,
wherein the processor is configured to
generate the integrated time-series information by using an external information analysis function for analysis of the visual information and an external audio analysis function for conversion of the audio information into character string information, analyzing the time-series media information for each time interval, and aligning annotation information obtained from the external information analysis function and time-stamped character string information obtained from the external audio analysis function on a common time reference.

### Supplementary 3

The system according to supplementary 1,
wherein the processor is configured to
embed, in the prompt sentence, structured data including the time intervals indicating the elements that are potentially inappropriate, character string information corresponding to the time intervals, visual annotation information corresponding to the time intervals, and the evidence information related to the elements, and instruct the generative information processing model to generate, for each time interval, a determination reason regarding presence or absence of inappropriateness and a plurality of concrete editing proposals in a designated output format.

### Application Example 1

### Supplementary 1

A system comprising a processor,
wherein the processor is configured to
obtain visual information and audio information of digital content to be posted, and divide the visual information and the audio information into analysis target data for each unit time based on time information,
analyze the visual information by using an image processing program and a discrimination information processing model to determine an object, an action, and a scene, and generate first detection result data indicating an element that has a possibility of being inappropriate, analyze the audio information by using a speech recognition program to convert the audio information into character string data, analyze the character string data by using a text classification information processing model or a rule set, and generate second detection result data indicating an expression that has a possibility of being inappropriate,
integrate the first detection result data and the second detection result data based on the time information, and generate integrated detection result data which, for each interval of the digital content that has a possibility of being inappropriate, includes a start time, an end time, a type of a corresponding element, and a detection reason,
generate a prompt sentence, based on the integrated detection result data and analysis context data including a content providing condition, the prompt sentence being to instruct a generative information processing model to generate an editing method for the element that has a possibility of being inappropriate,
analyze response data acquired from the generative information processing model, and generate editing candidate data representing a plurality of editing plans, each editing plan including a specific editing operation procedure such as deletion, masking, audio removal, or alternative information superimposition for each interval that has a possibility of being inappropriate,
present the editing candidate data, together with time information, an editing type, and an outline of an editing result, via a user operation display interface, and acquire a selection operation of an editing plan from a user,
execute video signal processing and audio signal processing on the digital content based on the editing plan corresponding to the selection operation acquired from the user, and generate edited digital content data and store the edited digital content data in a storage device, generate, based on the detection reason included in the integrated detection result data and the response data acquired from the generative information processing model, an explanation sentence in natural language for each element that has a possibility of being inappropriate, and present the explanation sentence via the user operation display interface, and adjust a presentation order or contents of the editing candidate data based on an operation history and reaction information of the user.

### Supplementary 2

The system according to supplementary 1,
wherein the processor is configured to generate the prompt sentence as structured information including summary data of the visual information included in the integrated detection result data, transcription data of the audio information, a type of the element that has a possibility of being inappropriate, and the content providing condition, and input the prompt sentence to the generative information processing model.

### Supplementary 3

The system according to supplementary 1,
wherein, in generating the edited digital content data, the processor is configured to automatically generate a plurality of edited digital content candidates corresponding to the plurality of editing plans included in the editing candidate data, present the plurality of edited digital content candidates in parallel via the user operation display interface, and accept a selection from the user in real time.

### Example 2

### Supplementary 1

A system comprising a processor,
wherein the processor is configured to
acquire electronic content to be posted, and analyze visual information and audio information constituting the electronic content based on time information to extract content features, and specify sections that are potentially inappropriate based on the content features and the time information of the electronic content, and record section information including a start time, an end time, and a type of inappropriateness for each of the sections, and
generate, in a natural language, a prompt sentence for a generative AI model based on the section information and a content summary of the electronic content, the prompt sentence instructing the generative AI model to perform editing processing to remove or modify the sections that are potentially inappropriate from the electronic content, and input the prompt sentence and the section information to the generative AI model, and
obtain, from the generative AI model, information on a plurality of editing plans or a plurality of edited electronic content candidates, each of the editing plans or edited electronic content candidates applying at least two or more different editing methods to the sections that are potentially inappropriate, and
control a program-controlled data processing apparatus, based on the editing plans, to generate a plurality of edited electronic content candidates by removing the sections that are potentially inappropriate from the electronic content, or by processing the sections by visual masking, audio muting, or a combination thereof, and
present the plurality of edited electronic content candidates to a user terminal, receive a candidate selected by a user, and determine the selected edited electronic content as final electronic content for posting, and
present, in a natural language, a reason for specifying the sections that are potentially inappropriate to the user, recognize an emotional state of the user based on a reaction of the user, and adjust the prompt sentence or generation conditions of the plurality of edited electronic content candidates according to the emotional state.

### Supplementary 2

The system according to Supplementary 1,
wherein the processor is configured to
analyze the visual information and the audio information of the electronic content for each of time-segmented units, and include, in the prompt sentence for the generative AI model, the content features for each of the units and the time information associated with each of the units.

### Supplementary 3

The system according to Supplementary 1,
wherein the processor is configured to
cause the user terminal to generate an interactive display screen including summary information, reduced-size images, or short-time playback information of the plurality of edited electronic content candidates, sequentially receive candidate selection operations by the user, and transmit a selection result to the system in real time.

### Application Example 2

### Supplementary 1

A system comprising a processor,
wherein the processor is configured to
analyze a content of posting-target information content and extract candidate inappropriate elements as time-series information,
construct a prompt sentence for instructing a generative information processing model to determine validity of the candidate inappropriate elements and to generate an editing policy, based on an analysis result including visual information and auditory information corresponding to the candidate inappropriate elements,
generate explanation information for presenting, in a natural language, reasons for the candidate inappropriate elements to a user, based on a determination result and the editing policy regarding the candidate inappropriate elements obtained from the generative information processing model,
determine, for each of a plurality of editing plans based on the explanation information and the editing policy, an editing operation sequence for generating edited candidate content of the information content,
estimate an emotional state of the user based on expression information and voice information of the user at a time of acquisition or viewing of the information content, adjust, with prioritization, editing details of at least a part of the edited candidate content, including at least one of deletion, masking, sound volume control, and replacement of acoustic information, based on the emotional state and the editing operation sequence, transmit the adjusted edited candidate content to a user terminal in association with identification information and the explanation information, and
receive selection information of the edited candidate content from the user terminal and execute a final editing process on the information content based on the selection information.

### Supplementary 2

The system according to supplementary 1,
wherein the processor is configured to divide visual information and auditory information constituting the posting-target information content into time-series units, extract features from the time-series units, and input a detection result based on the features as a part of the prompt sentence to the generative information processing model.

### Supplementary 3

The system according to supplementary 1,
wherein the processor is configured to
cause the user terminal to display the adjusted edited candidate content together with time-series position information and the explanation information, accept, successively, selection operations of the edited candidate content by the user, and transmit, to the system, the selection information corresponding to the selection operations.

What is claimed is:

1. A system comprising:
circuitry configured to:
receive, from a client terminal via a packet-switched network, time-series data comprising visual information and audio information associated with temporal metadata;
segment the time-series data into analysis units based on the temporal metadata, each analysis unit corresponding to a time interval within the time-series data;
analyze the visual information of each analysis unit using a convolutional neural network to extract visual feature vectors and generate first detection data indicating element types, spatial coordinates, and confidence scores for each time interval;
analyze the audio information of each analysis unit using a speech recognition model to convert the audio information into character string data with time-aligned boundaries, and process the character string data using a text classification model to generate second detection data indicating expression categories and confidence scores for each time interval;
integrate the first detection data and the second detection data based on the temporal metadata to generate integrated detection data that associates, for each unified time interval, a start time, an end time, at least one element type, and evidence information;
generate a prompt sentence based on the integrated detection data, the prompt sentence instructing a generative neural network model to generate, for each unified time interval, a determination regarding identified elements and a plurality of editing proposals;
input the prompt sentence to the generative neural network model and obtain response data comprising the editing proposals for each unified time interval;
generate, based on the evidence information and the response data,
explanation data in natural language that describes reasons for the identified elements, and transmit the explanation data to the client terminal via the packet-switched network;
determine, based on the response data and operation data received from the client terminal, an editing operation sequence specifying at least one editing process for each unified time interval, and generate a plurality of edited data candidates in accordance with the editing operation sequence; and
transmit the plurality of edited data candidates to the client terminal via the packet-switched network, receive selection data from the client terminal, and designate a selected one of the edited data candidates as final output data.

2. The system according to claim 1, wherein the circuitry is configured to generate the integrated detection data by aligning annotation information obtained from the visual feature vectors and time-stamped character string data obtained from the speech recognition model onto a common time reference, and merging overlapping time intervals into the unified time intervals.

3. The system according to claim 1, wherein the circuitry is configured to embed, in the prompt sentence, structured data comprising the unified time intervals, the character string data corresponding to each unified time interval, visual annotation labels corresponding to each unified time interval, and the evidence information, and to instruct the generative neural network model to output the editing proposals in a designated structured format.

4. The system according to claim 1, wherein the circuitry is configured to apply, for each unified time interval, the at least one editing process selected from a deletion process that removes data within the time interval, a masking process that obscures visual information within the time interval, an audio disabling process that attenuates audio information within the time interval, and a replacement process that substitutes alternative data within the time interval.

5. The system according to claim 4, wherein the circuitry is configured to generate the plurality of edited data candidates by applying different combinations of the editing processes to the unified time intervals, such that each edited data candidate represents a distinct editing strategy.

6. The system according to claim 1, wherein the circuitry is configured to estimate an emotional state of a user based on at least one of expression information and voice information received from the client terminal, and to adjust a presentation order or selection of the plurality of edited data candidates based on the estimated emotional state.

7. The system according to claim 6, wherein the circuitry is configured to adjust, based on the estimated emotional state, at least one of a strictness level of the editing processes, a number of the edited data candidates generated, and a prioritization of editing process types within the editing operation sequence.

8. The system according to claim 1, wherein the circuitry is configured to generate the first detection data by processing each analysis unit through the convolutional neural network to compute feature maps, applying an object detection algorithm to obtain bounding box coordinates and class probabilities, and comparing the class probabilities against predetermined threshold values stored in a database.

9. The system according to claim 1, wherein the circuitry is configured to generate the second detection data by converting the audio information into spectral feature representations, processing the spectral feature representations through the speech recognition model to obtain time-aligned transcript tokens, and classifying the transcript tokens using the text classification model to assign category labels based on comparison with threshold values.

10. The system according to claim 1, wherein the circuitry is configured to construct the prompt sentence by selecting a prompt template based on a policy configuration, inserting the unified time intervals and corresponding element types into the prompt template, and appending the evidence information as structured context data within the prompt sentence.

11. The system according to claim 1, wherein the circuitry is configured to parse the response data from the generative neural network model to extract, for each unified time interval, an operation type, time range parameters, and spatial region parameters, and to map the extracted information into machine-executable editing commands for a media processing pipeline.

12. The system according to claim 1, wherein the circuitry is configured to generate reduced-size preview data and short-time playback segments for each of the plurality of edited data candidates, and to transmit the preview data and playback segments to the client terminal via the packet-switched network for comparative display.

13. The system according to claim 1, wherein the circuitry is configured to store an operation history comprising past selection data and interaction patterns associated with a user, and to adjust a presentation order of the editing proposals based on the operation history such that editing process types previously selected by the user are prioritized.

14. The system according to claim 1, wherein the time-series data comprises digital content scheduled to be posted on an online distribution platform, and the circuitry is configured to apply a policy configuration specifying content category constraints and target audience parameters when generating the integrated detection data.

15. The system according to claim 14, wherein the circuitry is configured to generate the prompt sentence to instruct the generative neural network model to evaluate the identified elements against the content category constraints and to propose the editing proposals in compliance with the target audience parameters.

16. The system according to claim 1, wherein the circuitry is configured to optimize the editing operation sequence by merging adjacent or overlapping editing operations and ordering the editing operations to minimize a number of decoding and encoding passes applied to the time-series data.

17. The system according to claim 1, wherein the circuitry is configured to retrain the text classification model using feedback data comprising past selection data and user-indicated corrections received from the client terminal, by computing a loss function between predicted category labels and corrected labels and updating model parameters using a gradient-based optimization algorithm.

18. A system comprising:
circuitry configured to:
receive, from a client terminal via a packet-switched network, time-series data comprising visual information and audio information associated with temporal metadata;
segment the time-series data into analysis units based on the temporal metadata;
analyze the visual information using a convolutional neural network to generate first detection data indicating element types and confidence scores for each analysis unit;
analyze the audio information using a speech recognition model and a text classification model to generate second detection data indicating expression categories for each analysis unit;
integrate the first detection data and the second detection data based on the temporal metadata to generate integrated detection data associating unified time intervals with element types and evidence information;
generate a prompt sentence based on the integrated detection data, the prompt sentence instructing a generative neural network model to generate editing proposals for each unified time interval;
input the prompt sentence to the generative neural network model and obtain response data;
generate explanation data based on the evidence information and the response data;
determine an editing operation sequence based on the response data and operation data received from the client terminal;
generate a plurality of edited data candidates in accordance with the editing operation sequence;
estimate an emotional state of a user based on at least one of expression information and voice information received from the client terminal;
adjust at least one of the editing operation sequence and a presentation order of the edited data candidates based on the estimated emotional state; and
transmit the adjusted edited data candidates and the explanation data to the client terminal via the packet-switched network.

19. The system according to claim 18, wherein the circuitry is configured to transmit reduced-size preview data for each of the adjusted edited data candidates to the client terminal, receive selection data indicating a user-selected candidate, and designate the user-selected candidate as final output data.

20. A method performed by circuitry, the method comprising:
receiving, from a client terminal via a packet-switched network, time-series data comprising visual information and audio information associated with temporal metadata;
segmenting the time-series data into analysis units based on the temporal metadata;
analyzing the visual information using a convolutional neural network to generate first detection data indicating element types and confidence scores;
analyzing the audio information using a speech recognition model and a text classification model to generate second detection data indicating expression categories;
integrating the first detection data and the second detection data based on the temporal metadata to generate integrated detection data;
generating a prompt sentence based on the integrated detection data, the prompt sentence instructing a generative neural network model to generate editing proposals;
inputting the prompt sentence to the generative neural network model and obtaining response data;
generating explanation data based on evidence information and the response data;
determining an editing operation sequence based on the response data and operation data received from the client terminal;
generating a plurality of edited data candidates in accordance with the editing operation sequence; and
transmitting the plurality of edited data candidates to the client terminal via the packet-switched network.
